(19) United States
(12) Patent Application Publication
(10) Pub. No.: US 2026/0355754 A1
(43) Pub. Date: Nov. 12, 2026

(54) MULTI-CHANNEL ROTATING SEAL

(71) Applicant: FIBERLITE CENTRIFUGE LLC, Santa Clara, CA (US)

(72) Inventor: Sina PIRAMOON, Santa Clara, CA (US)

(21) Appl. No.: 19/123,974

(22) PCT Filed: Oct. 24, 2023
(86) PCT No.: PCT/US2023/077622

§ 371 Date: Apr. 24, 2025

Related U.S. Application Data
(60) Provisional application No. 63/380,623, filed on Oct. 24, 2022.

(51) Int. Cl. B04B 5/04; B04B 9/12

(52) U.S. Cl. CPC B04B 5/0442; B04B 9/12

(57) ABSTRACT

A rotating seal configured to convert a batch centrifuge rotor to a continuous flow centrifuge rotor is provided. The rotating seal includes a static feed and a rotary module. The static feed hub includes an internal coolant chamber configured to provide cooling to components of the rotating seal, a first fluid passageway, a second fluid passageway, and a third and a fourth passageway fluidly connected to the internal coolant chamber through which fluid coolant is provided. The rotary module includes a first plurality of openings and a second plurality of openings with are in fluid communication with the first and second fluid passageways of the static feed hub, respectively, to pass a first and a second liquid medium through the rotating seal. The rotating seal further includes a bearing assembly and at least one lip seal located between the body of the static feed hub and the rotary module.

### RELATED APPLICATIONS

The present application claims priority to and the benefit of U.S. patent application No. 63/380,623, “Multichannel Rotating Seal With Cooling Hub” (filed Oct. 24, 2022). All foregoing applications are incorporated herein by reference in their entireties for any and all purposes.

### TECHNICAL FIELD

The present invention relates generally to centrifuge rotors and, more particularly, to a rotor configured for continuous processing of biological suspensions in a centrifuge.

### BACKGROUND

Bioreactors and fermenters are used to grow biological suspensions that include cells or microorganisms suspended in a liquid medium. Once a biological suspension has been sufficiently grown, it is typically separated into liquid and solid components. The separated components are then harvested for subsequent analysis or use. Centrifugation is a common technique for separating biological components, such as cells, organelles, and biopolymers, including proteins, nucleic acids, lipids, and carbohydrates dispersed in biological suspension.

Centrifugation typically involves dispensing quantities of a suspension from a bioreactor or fermenter into a processing container, such as a bottle or a bag. This process is often referred to in industry as batch centrifugation. The loaded container is then closed and spun in a centrifuge. The centrifugal force created by spinning a rotor in the centrifuge causes the solids in the suspension to settle out and form a generally solid pellet toward the bottom of the container. A supernatant comprising liquid that is less dense than the pellet collects in the container above the pellet. In other cases, a density gradient may form in the suspension, with isopycnic layers of liquid containing solids of similar densities forming one on top of the other. In either case, once the supernatant and pellet or the isopycnic layers have formed, the separated components may be decanted by pouring, pumping, or otherwise removing each component from the container.

Conventional centrifugation processes have a number of shortcomings. For example, in order to increase throughput, particularly for a batch centrifuge rotor, it is typically desirable for the containers to hold as much suspension as possible. However, as the size of the container is increased, it becomes more difficult for an operator to place containers in and remove containers from the centrifuge. To this end, the increase in container size may require a larger rotor. Increasing the number of containers which are loaded into the centrifuge can also increase throughput. However, this may also necessitate the use of a larger rotor. A large number of containers can also increases the amount of time it takes the operator to load and unload each batch of containers from the centrifuge. To this end, it may be impracticable to have several different rotor sizes on hand to accommodate for different suspension processing needs.

Another problem with batch centrifugation is the removal of each of the various separated components without disturbing the other components. This problem can be exacerbated if the containers are large or otherwise difficult to remove from the centrifuge due to increased jostling of the container, which can cause remixing of the separated components.

Thus, there is a need for improved methods and systems for centrifugation of biological suspensions. In particular, a need exists for a means to convert conventional batch-type centrifuge rotors to operate as a continuous flow rotor system to increase suspension throughput without the shortcomings described above.

### SUMMARY

The present invention overcomes the foregoing and other shortcomings and drawbacks of centrifugation of biological suspensions using a batch-type rotor. While the present invention will be discussed in connection with certain embodiments, it will be understood that the present invention is not limited to the specific embodiments described herein.

According to a first embodiment, a rotating seal for a batch centrifuge rotor is provided. The batch centrifuge rotor includes a plurality of vessels arranged for rotation about a rotational axis of the centrifuge rotor, with each vessel being configured to hold a liquid medium for centrifugation. In that regard, each vessel includes a liquid medium inlet port and a liquid medium outlet port. The rotating seal is configured to be received by a hub of the centrifuge rotor to thereby convert the batch centrifuge rotor to operate as a continuous flow centrifuge rotor. As such, the rotating seal includes a static feed hub with a head portion configured to extend through a lid of the centrifuge rotor and a cylindrical hub body that extends from the head portion to a base. The static feed hub further includes an internal coolant chamber configured to provide cooling to components of the rotating seal. The static feed hub further includes the following: a first passageway configured to fluidly connect a first port located on the head portion to a first opening formed in the hub body, a second passageway configured to fluidly connect a second port located on the head portion to a second opening formed in the hub body, and a third and a fourth passageway configured to fluidly connect a third and a fourth port located on the head portion to the internal coolant chamber through which fluid coolant is provided to adjust a temperature of the static feed hub. The rotating seal further includes a rotary module that includes a body with an annular sidewall and a base that define a cavity (which can be considered a rotary cavity or a rotary module cavity) configured to operatively receive the feed hub therein. The base includes a base insert configured to couple the rotary module to the hub of the centrifuge rotor for rotation of the rotary module about the static feed hub. The body of the rotary module includes a first plurality of openings formed in the annular sidewall with each of the first plurality of openings being in fluid communication with the opening to the first passageway. In that regard, the first plurality of openings are configured to be fluidly connected to the liquid medium inlet port of one vessel of the centrifuge rotor with a first fluid line to pass a first liquid medium between the first fluid passageway of the static feed hub and the liquid medium inlet port of the vessel of the centrifuge rotor. The body of the rotary module further includes a second plurality of openings formed in the annular sidewall with each of the second plurality of openings being in fluid communication with the opening to the second passageway. The second plurality of openings are configured to be fluidly connected to the liquid medium outlet port of one vessel of the centrifuge rotor with a second fluid line to pass a second liquid medium between the liquid medium outlet port and the second fluid passageway of the static feed hub. The rotating seal further includes a bearing assembly located within the rotary cavity and between the body of the static feed hub and the body of the rotary module, and at least one lip seal located within the rotary cavity and between the body of the static feed hub and the body of the rotary module.

In one aspect, the rotating seal may include a first chamber formed between the static feed hub and the rotary module that is configured to pass the first liquid medium between the first opening to the first passageway and each of the first plurality of openings formed in the annular sidewall of the rotary module. For example, the first chamber may be annular in shape. The rotating seal may also include a second chamber formed between the static feed hub and the rotary module that is configured to pass the second liquid medium between the second opening to the second passageway and each of the second plurality of openings formed in the annular sidewall of the rotary module, the second chamber being fluidly isolated from the first chamber. To this end, the second opening to the second fluid passageway may be formed in the base of the static feed hub.

In another aspect, the rotary module may include a bearing cap coupled to a top of the body of the rotary module to form a bearing chamber configured to receive the bearing assembly. For example, in one aspect, the bearing cap includes an opening through which the static feed hub extends.

In yet another aspect, the body of the rotary module includes a first body segment, a second body segment, and a base segment coupled together in a coaxial arrangement to define the cavity configured to receive the static feed hub. In another aspect, the first body segment includes the first plurality of openings formed therein and the second body segment includes the second plurality of openings formed therein.

In one aspect, the at least one lip seal may include a first lip seal and a second lip seal. The first lip seal may be positioned between the static feed hub body and the first plurality of openings formed in the first body segment such that the first chamber is formed between the first lip seal and the hub body. In another aspect, the first lip seal may include a plurality of radially extending bores configured to pass the first liquid medium between the first chamber and the first plurality of openings formed in the annular sidewall of the rotary module. For example, in one aspect, each of the plurality of radially extending bores includes a fluid guide that extends into a corresponding one of the first plurality of openings formed in the annular sidewall of the rotary module. In one aspect, the second lip seal may be positioned between the static feed hub body and the second body segment such that the second chamber is formed between the second lip seal and the second body segment, the base segment, and the base of the static feed hub.

According to another embodiment, a rotor assembly is provided. The rotor assembly includes a housing with a cover and a rotor configured to rotate with the housing and the cover. The rotor includes a plurality of vessels arranged about a rotational axis of the rotor. The vessels are adapted to receive a volume of liquid medium for centrifugation and each include a liquid medium inlet port and a liquid medium outlet port. The rotor assembly further includes a rotating seal. The rotating seal includes a static feed hub with a head portion configured to extend through a lid of the centrifuge rotor and a cylindrical hub body that extends from the head portion to a base. The static feed hub further includes an internal coolant chamber configured to provide cooling to components of the rotating seal. The static feed hub further includes the following: a first passageway configured to fluidly connect a first port located on the head portion to a first opening formed in the hub body, a second passageway configured to fluidly connect a second port located on the head portion to a second opening formed in the hub body, and a third and a fourth passageway configured to fluidly connect a third and a fourth port located on the head portion to the internal coolant chamber through which fluid coolant is provided to adjust a temperature of the static feed hub. The rotating seal further includes a rotary module that includes a body with an annular sidewall and a base that define a cavity configured to operatively receive the feed hub therein. The base includes a base insert configured to couple the rotary module to the hub of the centrifuge rotor for rotation of the rotary module about the static feed hub. The body of the rotary module includes a first plurality of openings formed in the annular sidewall with each of the first plurality of openings being in fluid communication with the opening to the first passageway. In that regard, the first plurality of openings are configured to be fluidly connected to the liquid medium inlet port of one vessel of the centrifuge rotor with a first fluid line to pass a first liquid medium between the first fluid passageway of the static feed hub and the liquid medium inlet port of the vessel of the centrifuge rotor. The body of the rotary module further includes a second plurality of openings formed in the annular sidewall with each of the second plurality of openings being in fluid communication with the opening to the second passageway. The second plurality of openings are configured to be fluidly connected to the liquid medium outlet port of one vessel of the centrifuge rotor with a second fluid line to pass a second liquid medium between the liquid medium outlet port and the second fluid passageway of the static feed hub. The rotating seal further includes a bearing assembly located within the rotary cavity and between the body of the static feed hub and the body of the rotary module, and at least one lip seal located within the rotary cavity and between the body of the static feed hub and the body of the rotary module. In one aspect, a centrifuge is provided with the rotor assembly.

According to another aspect, the rotor assembly may further include a plurality of fluid line supports positioned between the rotating seal and the plurality of vessels of the rotor to maintain a position of each first and second fluid line during rotation of the rotor. For example, in one aspect, each of the plurality of fluid line supports may include a body with a first passageway configured to direct the first fluid line from one of the first plurality of openings to the liquid medium inlet port of one vessel of the rotor and a second passageway configured to direct the second fluid line from one of the second plurality of openings to the liquid medium outlet port of the same one vessel of the rotor.

According to yet another aspect, the rotor assembly may include a crown that is removably attachable to the rotary module of the rotating seal to secure the plurality of fluid line supports during rotation of the rotor. In one aspect, the crown may include an opening through which the head portion of the static feed hub is configured to extend.

According to another embodiment, a rotating seal for a batch centrifuge rotor is provided. The batch centrifuge rotor includes a plurality of vessels arranged for rotation about a rotational axis of the centrifuge rotor. Each vessel is configured to hold a liquid medium for centrifugation and includes a liquid medium inlet port and a first and a second liquid medium outlet port. The rotating seal is configured to be received by a hub of the centrifuge rotor to convert the batch centrifuge rotor to operate as a continuous flow centrifuge rotor. In that regard, the rotating seal includes a static feed hub with a head portion and a cylindrical hub body that extends from the head portion to a base. The static feed hub includes an internal coolant chamber configured to provide cooling for components of the rotating seal. The static feed hub further includes the following: a first passageway configured to fluidly connect a first port located on the head portion to a first opening formed in the hub body, a second passageway configured to fluidly connect a second port located on the head portion to a second opening formed in the hub body, a third passageway configured to fluidly connect a third port located on the head portion to a third opening formed in the hub body, and a fourth and fifth passageway configured to fluidly connect a fourth and a fifth port located on the head portion to the internal coolant chamber through which fluid coolant is provided to adjust a temperature of the static feed hub. The rotating seal further includes a rotary module. The rotary module includes a body with an annular sidewall and a base that define a cavity configured to operatively receive the feed hub therein. The base includes a base insert configured to couple the rotary module to the hub of the centrifuge rotor for rotation of the rotary module about the static feed hub. The body includes a first plurality of openings formed in the annular sidewall with each of the first plurality of openings being in fluid communication with the first opening to the first passageway and configured to be fluidly connected to the liquid medium inlet port of one vessel of the centrifuge rotor with a first fluid line to pass a first liquid medium between the first fluid passageway of the static feed hub and the liquid medium inlet port of the vessel of the centrifuge rotor. The body also includes a second plurality of openings formed in the annular sidewall with each of the second plurality of openings being in fluid communication with the second opening to the second passageway and configured to be fluidly connected to the first liquid medium outlet port of one vessel of the centrifuge rotor with a second fluid line to pass a second liquid medium between the liquid medium outlet port and the second fluid passageway of the static feed hub. The body further includes a third plurality of openings formed in the annular sidewall with each of the third plurality of openings being in fluid communication with the third opening to the third passageway and configured to be fluidly connected to the second liquid medium outlet port of one vessel of the centrifuge rotor with a third fluid line to pass a third liquid medium between the second liquid medium outlet port and the third fluid passageway of the static feed hub. The rotating seal further includes a bearing assembly located within the rotary cavity and between the body of the static feed hub and the body of the rotary module, and at least one lip seal located within the rotary cavity and between the body of the static feed hub and the body of the rotary module.

According to one aspect, the rotating seal may include a first chamber formed between the static feed hub and the rotary module that is configured to pass the first liquid medium between the first opening to the first passageway and each of the first plurality of openings formed in the annular sidewall of the rotary module. The rotating seal may also includes a second chamber formed between the static feed hub and the rotary module that is configured to pass the second liquid medium between the second opening to the second passageway and each of the second plurality of openings formed in the annular sidewall of the rotary module. Further, the rotating seal may include a third chamber formed between the static feed hub and the rotary module that is configured to pass the third liquid medium between the third opening to the third passageway and each of the third plurality of openings formed in the annular sidewall of the rotary module. To this end, the first chamber, the second chamber, and the third chamber may be fluidly isolated from each other. Further, the first chamber and the second chamber may be annular in shape. In one aspect, the third chamber may be formed between the third lip seal and the third body segment, the base segment, and the base of the static feed hub. In a further aspect, the third opening to the third fluid passageway may be formed in the base of the static feed hub.

According to another aspect, the rotary module may include a bearing cap coupled to a top of the body of the rotary module to form a bearing chamber configured to receive the bearing assembly. For example, in one aspect, the bearing cap may include an opening through which the static feed hub extends.

According to one aspect, the body of the rotary module may include a first body segment, a second body segment, a third body segment, and a base segment coupled together in a coaxial arrangement to define the cavity configured to receive the static feed hub. In that regard, the first body segment may include the first plurality of openings formed therein, the second body segment may include the second plurality of openings formed therein, and the third body segment may include the third plurality of openings formed therein.

According to yet another aspect, the at least one lip seal may include a first lip seal positioned between the static feed hub body and the first body segment, a second lip seal positioned between the static feed hub body and the second body segment, and a third lip seal positioned between the static feed hub body and the third body segment.

According to another embodiment, a rotor assembly is provided. The rotor assembly includes a rotor with a plurality of vessels arranged about a rotational axis of the rotor. Each vessel is adapted to receive a volume of liquid medium for centrifugation and includes a liquid medium inlet port, a first liquid medium outlet port, and a second liquid medium outlet port. The rotor assembly further includes a rotating seal. The rotating seal includes a static feed hub with a head portion and a cylindrical hub body that extends from the head portion to a base. The static feed hub includes an internal coolant chamber configured to provide cooling for components of the rotating seal. The static feed hub further includes the following: a first passageway configured to fluidly connect a first port located on the head portion to a first opening formed in the hub body, a second passageway configured to fluidly connect a second port located on the head portion to a second opening formed in the hub body, a third passageway configured to fluidly connect a third port located on the head portion to a third opening formed in the hub body, and a fourth and fifth passageway configured to fluidly connect a fourth and a fifth port located on the head portion to the internal coolant chamber through which fluid coolant is provided to adjust a temperature of the static feed hub. The rotating seal further includes a rotary module. The rotary module includes a body with an annular sidewall and a base that define a cavity configured to operatively receive the feed hub therein. The base includes a base insert configured to couple the rotary module to the hub of the centrifuge rotor for rotation of the rotary module about the static feed hub. The body includes a first plurality of openings formed in the annular sidewall with each of the first plurality of openings being in fluid communication with the first opening to the first passageway and configured to be fluidly connected to the liquid medium inlet port of one vessel of the centrifuge rotor with a first fluid line to pass a first liquid medium between the first fluid passageway of the static feed hub and the liquid medium inlet port of the vessel of the centrifuge rotor. The body also includes a second plurality of openings formed in the annular sidewall with each of the second plurality of openings being in fluid communication with the second opening to the second passageway and configured to be fluidly connected to the first liquid medium outlet port of one vessel of the centrifuge rotor with a second fluid line to pass a second liquid medium between the liquid medium outlet port and the second fluid passageway of the static feed hub. The body further includes a third plurality of openings formed in the annular sidewall with each of the third plurality of openings being in fluid communication with the third opening to the third passageway and configured to be fluidly connected to the second liquid medium outlet port of one vessel of the centrifuge rotor with a third fluid line to pass a third liquid medium between the second liquid medium outlet port and the third fluid passageway of the static feed hub. The rotating seal further includes a bearing assembly located within the rotary cavity and between the body of the static feed hub and the body of the rotary module, and at least one lip seal located within the rotary cavity and between the body of the static feed hub and the body of the rotary module. In one aspect, a centrifuge is provided with the rotor assembly.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to describe the one or more embodiments of the invention.

FIG. 1 is a perspective view of a rotating seal installed to an exemplary centrifuge rotor assembly in accordance with a first embodiment of the present invention.

FIG. 2 is a cross-sectional view of the centrifuge rotor assembly of FIG. 1.

FIG. 2A is a partial cross-sectional view of the rotor of the centrifuge rotor assembly of FIGS. 1-2, illustrating details of a rotor vessel.

FIG. 2B is a perspective partial cross-sectional view of the vessel of FIG. 2A, illustrating a cover of the vessel removed.

FIG. 3 is a partially disassembled perspective view of the rotor assembly of FIG. 1, depicting a housing, a lid, a rotor, and a crown.

FIG. 4 is a perspective view of the rotor depicted with the vessels removed, showing additional details of the rotating seal.

FIG. 4A is a disassembled perspective view of the rotating seal of FIGS. 1-2 and 3-4.

FIG. 4B is a schematic perspective view of a static feed hub of the rotating seal of FIG. 4A, illustrating fluid flow paths through the static feed hub.

FIG. 5 is a cross-sectional view of the rotating seal of FIG. 4A.

FIG. 6A is a cross-sectional view of the rotating seal of FIG. 5, schematically depicting flow of a first liquid medium, a second liquid medium, and a fluid coolant through the rotating seal.

FIG. 6B is a view similar to FIG. 6A, further schematically depicting flow of the second liquid medium through the rotating seal.

FIG. 7 is an enlarged cross-sectional view of the rotating seal taken along line 7 -7 of FIG. 6B, illustrating details of a first lip seal and a second lip seal.

FIG. 8 is a cross-sectional view taken along line 8 -8 of FIG. 6A, schematically illustrating flow of the first liquid medium through the rotating seal.

FIG. 9 is a cross-sectional view taken along line 9 -9 of FIG. 6A, schematically illustrating flow of the second liquid medium through the rotating seal.

FIG. 10 is a perspective cross-sectional view of the first lip seal of the rotating seal of FIGS. 1-9.

FIG. 11 is a perspective cross-sectional view of the second lip seal of the rotating seal of FIGS. 1-9.

FIG. 12 is a perspective view of a rotating seal installed to the rotor in accordance with a second embodiment of the present invention.

FIG. 13 is a disassembled perspective view of the rotating seal of FIG. 12.

FIG. 14A is a cross-sectional view of the rotating seal of FIGS. 12-13, schematically depicting flow of a first liquid medium, a second liquid medium, a third liquid medium, and a fluid coolant through the rotating seal.

FIG. 14B is a view similar to FIG. 14A, further schematically depicting flow of the liquid mediums and the fluid coolant through the rotating seal.

FIG. 14C is an enlarged view of the rotating seal of FIGS. 14A-14C, illustrating details of a first lip seal, a second lip seal, and a third lip seal.

FIG. 15 is a perspective view of a rotating seal in accordance with a third embodiment of the present invention.

FIG. 16A is a cross-sectional view taken along line 16A-16A of FIG. 15, schematically depicting flow of a first liquid medium, a second liquid medium, a third liquid medium, and a fluid coolant through the rotating seal.

FIG. 16B is a view similar to FIG. 16A, further schematically depicting flow of the liquid mediums and the fluid coolant through the rotating seal.

FIG. 17 is a cross-sectional view illustrating details of a body segment of the rotating seal.

FIG. 18 is a cross-sectional view of a centrifuge rotor assembly including the rotating seal of FIGS. 15-17 in accordance with an embodiment of the present invention.

FIG. 19 is a partially disassembled perspective view of the centrifuge rotor assembly of FIG. 18, illustrating a plurality of rotor vessels of the rotor assembly and the rotating seal of FIGS. 15-17.

FIG. 20 is a diagrammatic view showing a centrifuge rotor assembly including the rotating seal of FIGS. 15-17 installed in an exemplary centrifuge of a continuous flow centrifugation system in accordance with an embodiment of the present invention.

### DETAILED DESCRIPTION

Embodiments of the present invention are directed to a multichannel rotating seal for adapting a batch centrifuge rotor to operate as a continuous flow rotor for processing of biological suspensions. In that regard, the rotating seal provides a quick and easy way to convert a batch-type centrifuge rotor to operate as a continuous flow centrifuge rotor to increase suspension throughput through the rotor. In that regard, a continuous flow rotor enables large volumes of liquid suspension to be centrifuged without the need for frequently starting and stopping the rotor to fill and decant the centrifuge rotor containers. The rotating seal of the present invention is modular to vary the number of feed and/or discharge ports to facilitate the continuous transfer of a range of desired fluids to and from the rotor during centrifugation, such as the liquid suspension, the liquid supernatant, a buffer fluid, and/or a heavy fluid such as a density gradient, for example. These and other aspects of the present invention will be described in further detail below.

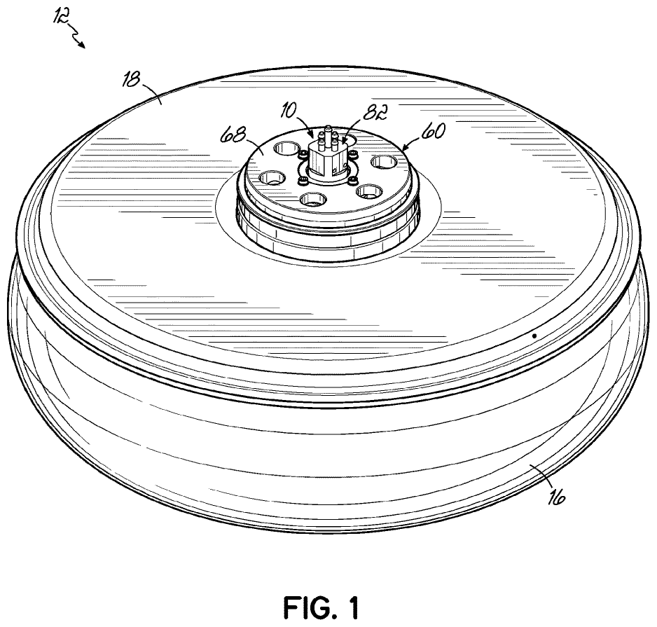

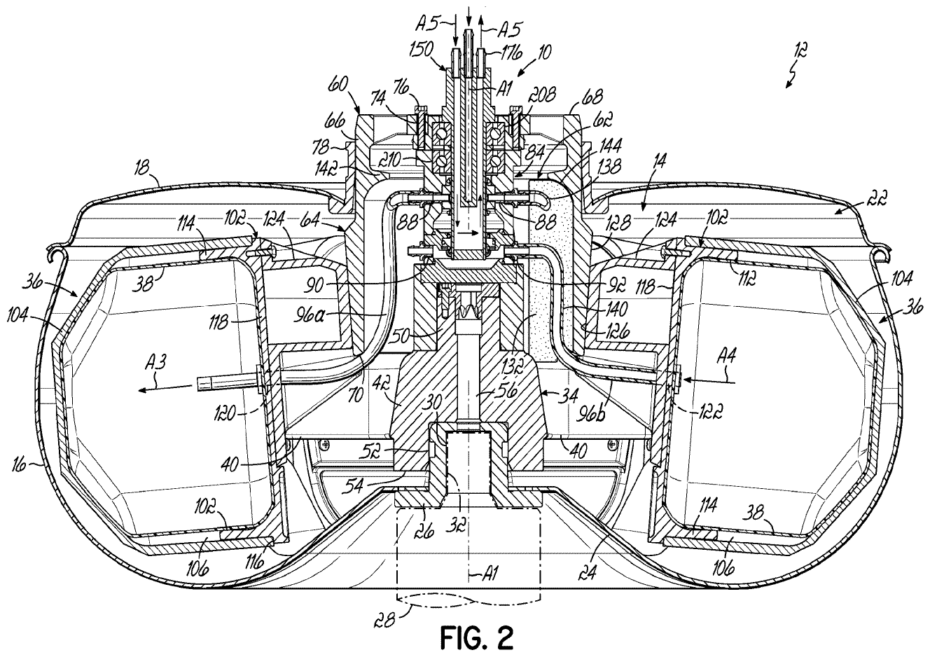

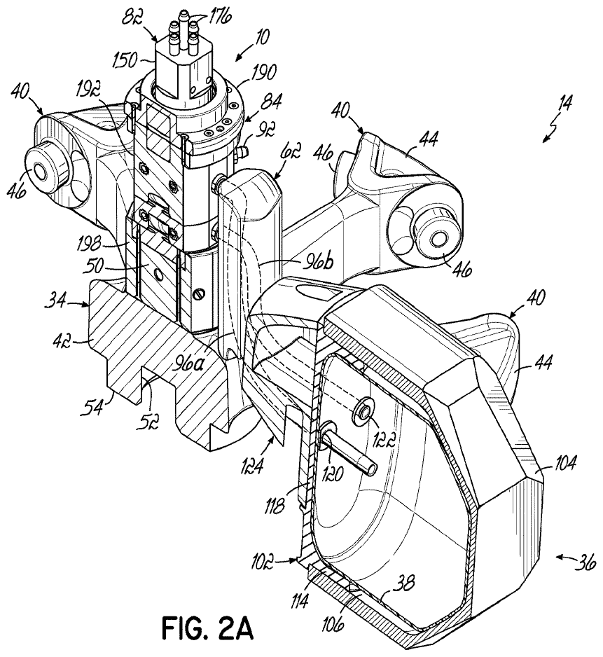

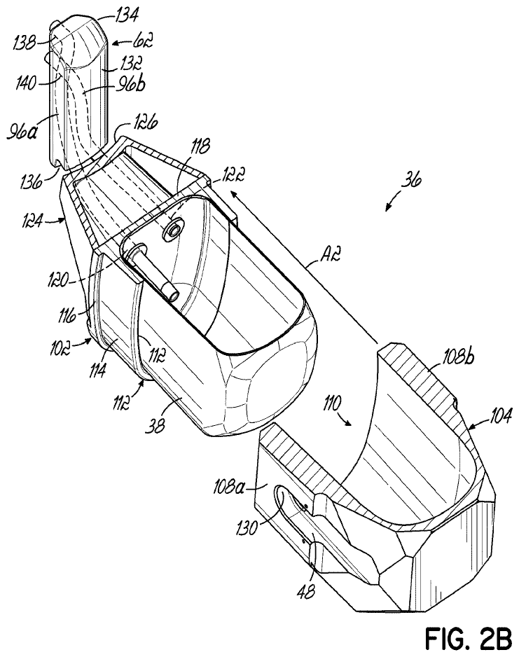

FIGS. 1-11 illustrate a multichannel rotating seal 10 in accordance with a first embodiment of the present invention. With reference to FIGS. 1-2 in particular, the rotating seal 10 is shown installed to an exemplary rotor assembly 12. The rotor assembly 12 includes a centrifuge rotor 14 and the rotating seal 10 is for converting the rotor 14, which may be a batch-type centrifuge rotor, into a continuous flow rotor, as will be described in further detail below. The exemplary rotor 14 may be the 6×2000 mL BIOS Swinging Bucket Rotor commercially available from the Assignee of the present disclosure, for example. However, while aspects of the rotating seal 10 are shown and described in the context of certain types of centrifuge rotors, it will be understood that the same inventive concepts related to aspects of the rotating seal 10 may be implemented with different centrifuge rotors and related systems. To this end, the drawings are not intended to be limiting.

Referring now to FIGS. 1-2 and 3, the rotor assembly 12 includes a housing 16, a lid 18, and the rotor 14. The lid 18 is configured to cover an open end 20 of the housing 16 to form a sealed chamber 22 for containing the rotor 14 during centrifugation of a liquid suspension, for example. The housing 16, which may alternatively be referred to as a wind shield, includes a base 24 with a centrally located hub 26 to which the rotor 14 is configured to be coupled for rotation about a central axis Al of rotation by a centrifuge drive 28. In that regard, as shown in FIG. 2, the housing hub 26 includes a socket 30 configured to receive a centrifuge spindle 32 of the centrifuge drive 28 for rotation of the rotor assembly 12 about the central axis A1 of rotation.

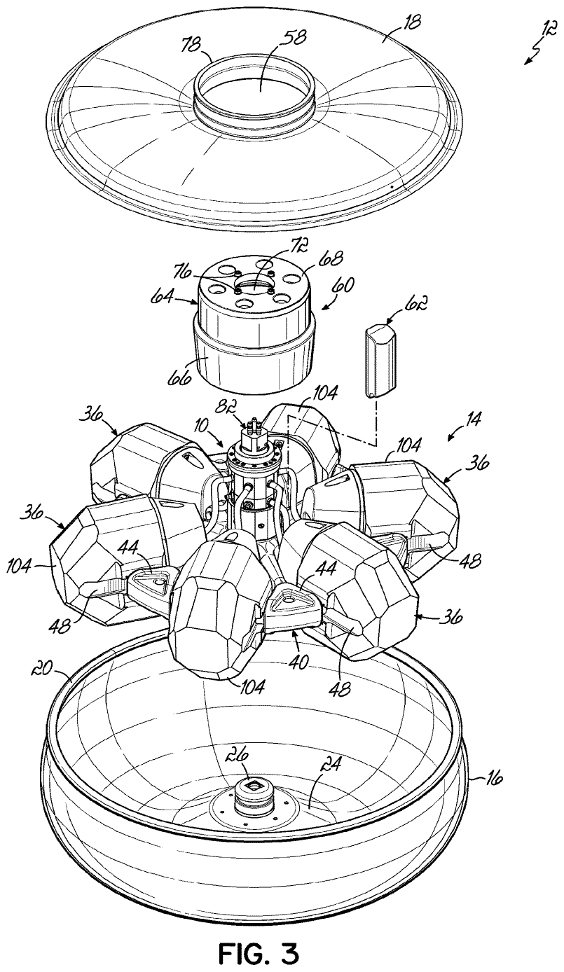

With reference to FIGS. 2-3, the centrifuge rotor 14 includes a rotor body 34 configured to support a plurality of swing buckets or vessels 36 arranged for rotation about the rotational axis A1 of the centrifuge rotor 14. In the embodiment shown, the rotor 14 supports six vessels 36. Each vessel 36 is configured to receive a flexible bag 38 filled with a volume of a liquid suspension for centrifugation, as will be described in further detail below. The vessels 36 are supported by a plurality of elongate vessel support arms 40. As shown, each vessel support arm 40 extends from a central core 42 of the rotor body 34 to a generally Y-shaped terminal end 44. The particular arrangement of the vessel support arms 40 is such that each of the vessel support arm 40 supports two vessels 36. In that regard, the terminal end 44 of each vessel support arm 40 includes a pair of trunnions (e.g., FIG. 2A) or hangers 46. Each trunnion 46 is configured to be removably received within a respective groove 48 formed in a side of a vessel 36 to support the vessel 36 between adjacent vessel support arms 40, as shown in FIG. 3, for example.

As described above, the rotor 14 is configured to be coupled to the hub 26 of the housing 16 for rotation with the rotor assembly 12 about the central axis A1 of rotation by the centrifuge drive 28. In that regard, as best shown in FIG. 2, the central core 42 of the rotor 14 includes a generally cylindrical boss 50 that projects axially upwardly from the central core 42 of the rotor 14 and a pocket 52 formed in a base 54 of the central core 42. The pocket 52 extends a distance into the central core 42, in an axial direction from the base 54, and is configured to receive a portion of the housing hub 26 therein for coupling the rotor 14 to the housing 16. To this end, the centrifuge rotor 14 may be operatively coupled to the housing hub 26 and the spindle 32 of the centrifuge drive 28 with one or more set screws, drive pins, or other suitable torque transferring member. In the embodiment shown, the central core 42 includes a central bore 56 that extends in an axial direction between the boss 50 and the pocket 52 that is configured to receive a fastener (not shown) therethrough for securing the rotor 14 to the centrifuge spindle 32.

With reference to FIGS. 2 and 3, the lid 18 of the rotor assembly 12 includes a central opening 58 through which a crown 60 and the rotating seal 10 is configured to extend. The crown 60 is configured to be attached to the rotating seal 10 to secure components such as a plurality of fluid line supports 62, the plurality of fluid lines that extend between the rotating seal 10 and each vessel 36, and certain other components of the rotating seal 10 and the rotor assembly 12 during centrifugal rotation of the rotor assembly 12. In that regard, the crown 60 includes a body 64 with an annular sidewall 66 that extends between a top wall 68 and an open end 70 of the crown 60. The top wall 68 includes an opening 72 through which a portion of the rotating seal 10 is configured to extend. The top wall 68 further includes a plurality of bores 74 through which fasteners 76 are received for attaching the crown 60 to the rotating seal 10, as will be described in further detail below.

As shown in FIG. 2, the lid 18 of the rotor assembly 12 is received over the crown 60 such that a portion of the crown 60 extends through the opening 58 in the lid 18. In that regard, the lid 18 includes an annular collar 78 configured to engage the annular sidewall 66 of the crown 60 to hold the lid 18 in place relative to the housing 20. The central opening 58 in the lid 18 provides access to the rotating seal 10 so that the necessary fluid lines may be connected to the exposed parts of the rotating seal 10 for both providing the desired liquid medium to the rotating seal 10 and to each rotor vessel 36 and for removing the desired liquid medium from the rotating seal 10 and each rotor vessel 36.

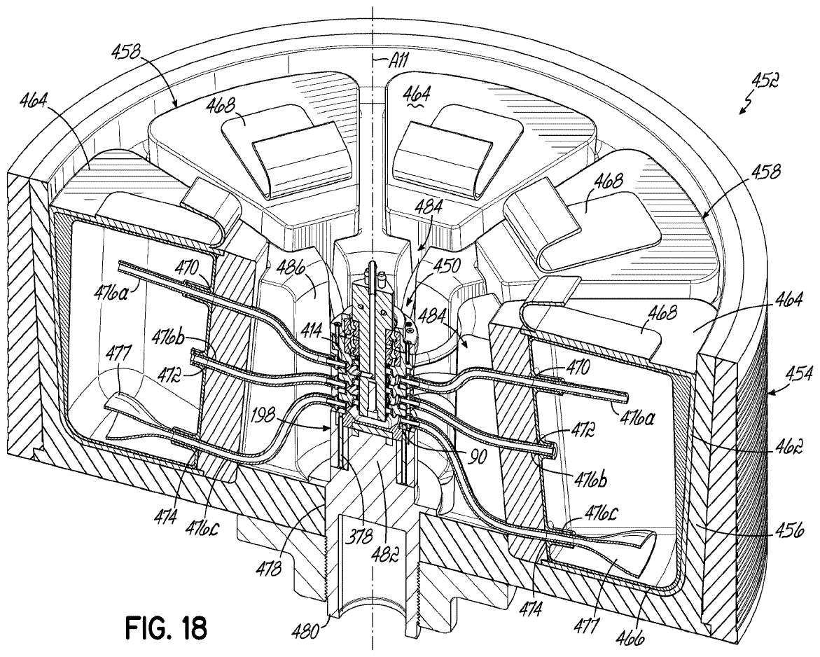

As briefly described above, the rotating seal 10 is configured to route process fluids, otherwise referred to as liquid medium, between the plurality of vessels 36 of the rotor 14 and one or more process fluid sources external to the rotor assembly 12 (e.g., FIG. 18). In that regard, the rotating seal 10 includes a static hub 82 supported within a rotary module 84 that is configured to rotate about the static feed hub 82. The static feed hub 82 is configured to be connected to one or more liquid medium storage containers that are external to the rotor assembly 12 with respective fluid lines. The rotary module 84 is configured to be coupled to the rotor body 34 for rotation with the rotor assembly 12 about the static feed hub 82. As will be described in further detail below, liquid medium is passed between the static feed hub 82 and rotary module 84, and between the rotary module 84 and the vessels 36, during high-speed centrifugal rotation of the rotor assembly 12.

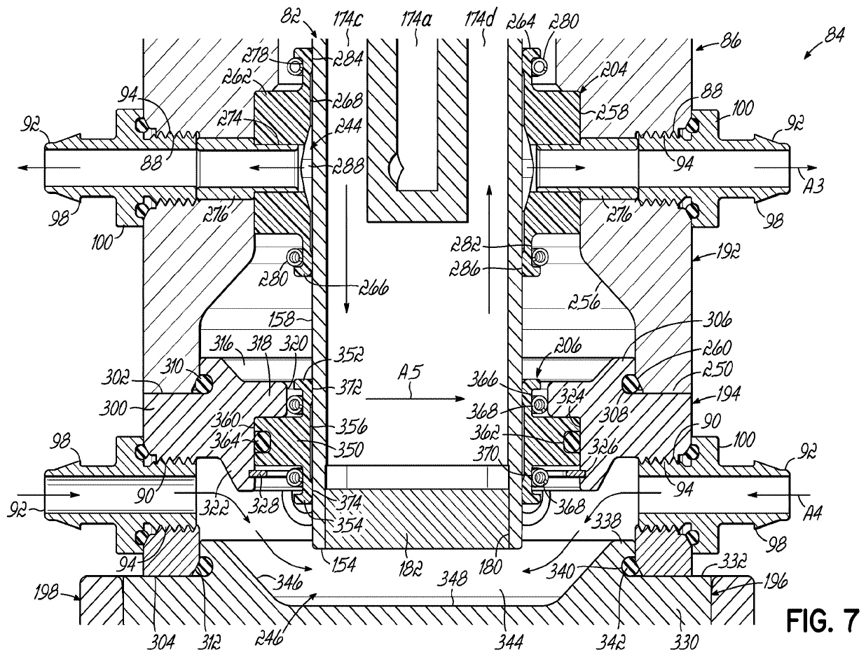

To transfer liquid medium between the rotary module 84 and the vessels 36 of the centrifuge rotor 14, the rotary module 84 includes a body 86 having a first and a second plurality of openings, 88, 90, each being distributed circumferentially about the rotary module body 86. As shown in FIGS. 2-3, each of the first plurality of openings 88 includes a first fitting 92 and is for directing a first process fluid or liquid medium between the rotating seal 10 and a vessel 36 of the rotor 14. Each opening 88 may be partially threaded to threadably receive a threaded end 94 of a respective fitting 92 (e.g., FIG. 7). Each fitting 92 is configured to receive one end of a first fluid line 96a, which may be flexible food grade polyvinyl chloride (PVC) tubing, with the other end of the fluid line 96a being connected to the flexible bag 38 located in a vessel 36, as will be described in further detail below. Similarly, each of the second plurality of openings 90 includes a fitting 92 and is for directing a second process fluid between the rotating seal 10 and a vessel 36 of the rotor 14. Each opening 90 may also be threaded to threadably receiving a threaded end 94 of a fitting 92. Each fitting 92 is configured to receive one end of a second fluid line 96b, with the other end of the fluid line 96b being connected to the flexible bag 38 located in a vessel 36 as will be described in further detail below. To this end, each fitting 92 includes a locking fishbone or barbed end 98 for facilitating the connection between the fitting 92 and fluid line 96a,96b. Each fitting 92 may also include a gasketed flange 100 configured to seal against surfaces of the rotary module 84 (e.g., FIG. 7).

As shown in FIG. 2A, one of the first fluid lines 96a and one of the second fluid lines 96b is connected between each vessel 36, and in particular each flexible bag 38, and the rotating seal 10 to provide a continuous flow of liquid medium between the vessel 36 and the rotating seal 10. In that regard, each vessel 36 is configured to support one flexible bag 38 during centrifugation. With reference to FIGS. 2-2B, each rotor vessel 36 includes a base 102 and a cover 104 removably attachable to the base 102 to define a cavity 106 configured to bound the flexible bag 38 therein. To this end, the flexible bag 38 generally conforms to the shape of the cavity 106 formed between the base 102 and the cover 104 of the vessel 36. The cover 104 of each vessel 36 includes a pair of opposing sidewalls 108a, 108b. Formed in each sidewall 108a, 108b is the radially extending groove 48. As described above, each groove 48 is configured to removably receive a respective trunnion 46 for supporting the vessel 36 between a pair of adjacent vessel support arms 40.

As shown in FIG. 2B, the cover 104 of each vessel 36 includes an open end 110 that is configured to be received over an open end 112 of the base 102 as indicated by directional arrow A2. The open end 112 of the base 102 is defined by an annular sidewall 114 which forms a sleeve over which the cover 104 is configured to be received. When the cover 104 is fully received over the annular sidewall 114 of the base 102, the cover 104 is in an abutting relationship with a shoulder 116 defined by a base wall 118 of the base 102. The base wall 118 of the base 102 is generally axially extending and includes a first port 120 and a second port 122 formed therein. The first port 120 is for receiving the first fluid line 96a connected between one of the first plurality of openings 88 of the rotary module 84 and the flexible bag 38. The second port 122 is for receiving the second fluid line 96b connected between one of the second plurality of openings 90 of the rotary module 84 and the flexible bag 38, as will be described in further detail below.

The vessel 36 further includes a spacer 124 attached to the base wall 118 of the base 102 of the vessel 36. As shown in FIGS. 2-2B, the spacer 124 includes an curved face 126 configured to engage a tapered portion 128 of the annular wall of the crown 60. In that regard, when the crown 60 is installed to the rotor assembly 12, as shown in FIG. 2, the engagement between the tapered portion 128 of the crown 60 and the curved face 126 biases each vessel 36 in a radially outwardly direction to seat each pair of trunnions 46 against a base 130 of each vessel groove 48. This configuration secures movement of the vessels 36 relative to the rotor 14 during rotation of the rotor 14 by the centrifuge drive 28. To this end, the spacer 124 also facilitates routing of the fluid lines 96a, 96b between each vessel 36 and the rotating seal 10, as described in further detail below.

As briefly described above, the rotor assembly 12 includes a plurality of fluid line supports 62 through which the fluid lines 96a, 96b connected between each vessel 36 and the rotating seal 10 extend. In particular, each fluid line support 62 is located between the rotating seal 10 and one of the plurality of vessels 36 of the rotor 14 to maintain a position of a corresponding pair of fluid lines 96a, 96b during rotation of the rotor 14. In that regard, each pair of fluid lines 96a, 96b that extend between one vessel 36 and the rotating seal 10 is routed through a fluid line support 62. Thus, the number of fluid line supports 62 corresponds to the number of vessels 36 supported by the rotor 14. In the exemplary embodiment shown, the rotor assembly 12 includes six fluid line supports 62.

With reference to FIGS. 2-2B, each of the plurality of fluid line supports 62 includes an elongate body 132 that extends between a first end 134 and an opposite second end 136. Each fluid line support 62 further includes a first passageway 138 configured to direct the first fluid line 96a from one of the first plurality of openings 88 to the first port 120 of one vessel 36 of the rotor 14 and a second passageway configured 140 to direct the second fluid line 96b from one of the second plurality of openings 90 to the second port 122 of the same one vessel 36 of the rotor 14. To this end, the first and second passageways 138, 140 generally extend from the first end 134 to the second end 138 of the body 132 of the fluid line support 62.

As best shown in FIG. 2, the crown 60 is configured to maintain a position of each of the plurality of fluid line supports 62 when attached to the rotating seal 10. In that regard, the plurality of fluid line supports 62 are received within the crown 60 and positioned between the body 64 of the crown 60 and the rotor 14. In particular, the body 132 of each fluid line support 62 is placed in engagement with the annular sidewall 66 of the crown 60. In that regard, the annular sidewall 66 of the crown 60 includes a radially inwardly extending lip 142 configured to engage a chamfered surface 144 at the first end 134 of each fluid line support 62 to hold each fluid line support 62 between the crown 60 and surfaces of central core 42 of the rotor body 34, as shown. To this end, the plurality of fluid line supports 62 are supported within the crown 60 in a spaced apart arrangement about the rotational axis Al of the centrifuge rotor 14.

With reference to FIGS. 2-2B, the pair of fluid lines 96a, 96b connected between each vessel 36 and the rotating seal 10 may be part of the flexible bag 38 such that the flexible bag 38 and the pair of fluid lines 96a, 96b are formed as an integral unitary piece. Alternatively, each pair of fluid lines 96a, 96b may be separate components. In any event, when each flexible bag 38 is enclosed within the cavity 106 of a respective vessel 36, the first fluid line 96a is routed through the first port 120 formed in the base 118 of the vessel 36, through the vessel 36 spacer 124, through the first passageway 138 of the fluid line support 62, and connected to a barbed end 98 of a respective fitting 92 of one of the first plurality of openings 88 of the rotary module 84. In the embodiment shown, a first liquid medium, such as a liquid suspension, may be flowed from the rotating seal 10 into the flexible bag 38 of each vessel 36 via each first fluid line 96a during centrifugal rotation of the rotor 14. Flow of the first liquid medium is indicated by directional arrows A3 in FIGS. 1-11. As such, the first port 120 to each vessel 36 may be considered a liquid medium inlet port.

The second fluid line 96b is routed through the second port 122 formed in the base 118 of the vessel 36, through the vessel spacer 124, through the second passageway 140 of the fluid line support 62, and connected to a barbed end 98 of a respective fitting 92 of one of the second plurality of openings 90 of the rotary module 84. In the embodiment shown, a second liquid medium such as a supernatant may be removed from the flexible bag 38 of each vessel 36 via each second fluid line 96b during centrifugal rotation of the rotor 14. Flow of the second liquid medium is indicated by directional arrows A4 in FIGS. 1-11. As such, the second port 122 to each vessel 36 may be considered a liquid medium outlet port. To this end, the rotating seal 10 is configured to simultaneously transfer the first liquid medium (i.e., suspension) from a source external to the rotor assembly 12 into each vessel 36 and the second liquid medium (i.e., supernatant) from each vessel 36 to a storage location external to the rotor assembly 12.

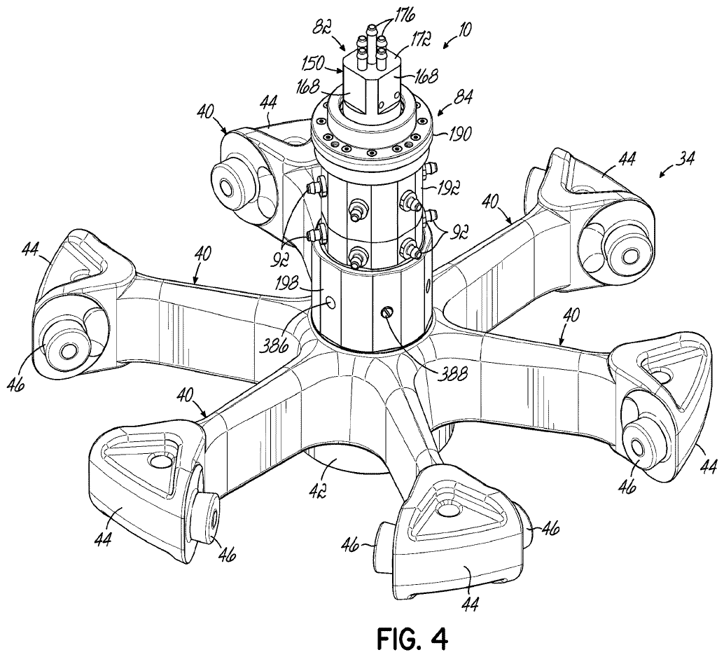

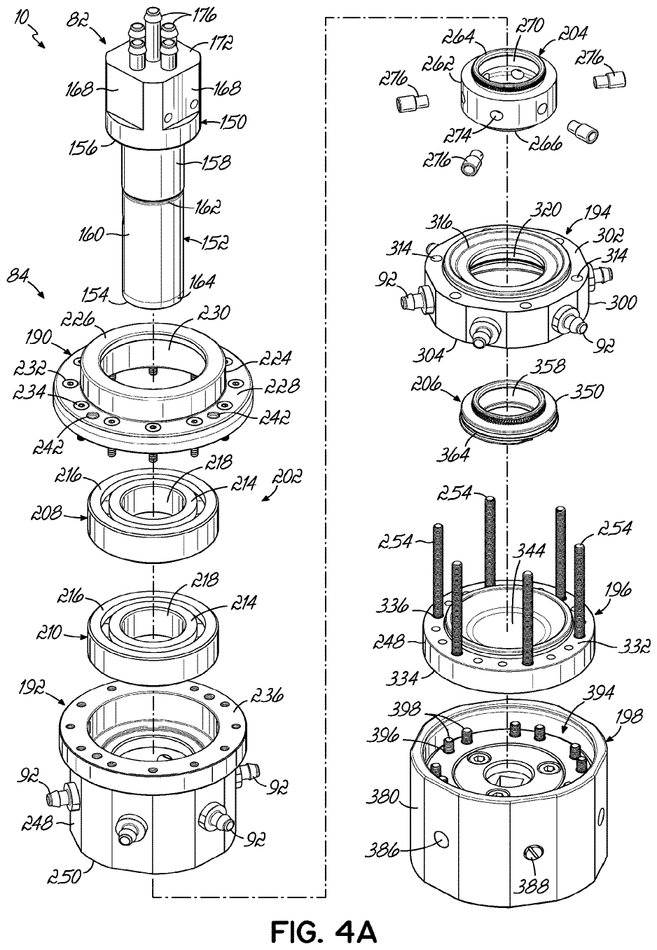

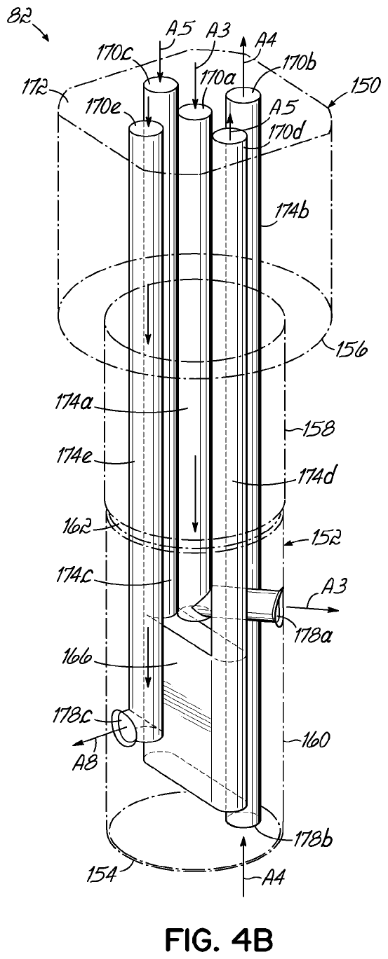

Having now described certain details of the rotor assembly 12, additional details of the rotating seal 10 will now be described. As briefly described above, the rotating seal 10 includes the static feed hub 82 which is configured to be stationary relative to the rotary module 84 which is configured to rotate about the static feed hub 82 during rotation of the rotor assembly 12 by the centrifuge drive 28. As shown in FIGS. 2 and 4-4B, the static feed hub 82 includes a head portion 150 and a cylindrical hub body 152 that extends from the head portion 150 to a base 154 of the static hub 82. A diameter of the head portion 150 is larger compared to a diameter of the hub body 152 to define a shoulder 156 therebetween. The cylindrical hub body 152 includes a bearing surface 158 and a seal surface 160 which are configured to be received within the rotary module 84. The bearing surface 158 and the seal surface 160 may be separated by an annular groove 162. The hub body 152 may include a circumferential chamfered portion, otherwise referred to as a lead-in chamfer 164, that extends between the base 154 and the seal surface 160 to facilitate installation of the static feed hub 82 to the rotary module 84. As shown in FIG. 4B, for example, the cylindrical hub body 152 further includes an internal coolant chamber 166 adjacent to the seal surface 160 that is configured to remove heat from at least the seal surface 160 and the static feed hub 82 that is generated as a result of the rotational engagement between the rotary module 84 and the static hub 82, as will be described in further detail below.

As shown in FIG. 2, the head portion 150 of the static feed hub 82 is configured to remain exposed from the rotary module 84. As such, process fluid lines may be attached to the head portion 150 of the static feed hub 82 for flowing process fluids to/from the rotating seal 10. Furthermore, the head portion 150 of the static feed hub 82 includes four flattened surfaces 168 which are configured to receive a torque transfer arbor of a centrifuge lid (not shown), for example, for securing the static feed hub 82 to the centrifuge and to reduce vibrations induced by the rotation of the rotor assembly 12.

With reference to FIGS. 4-4B, the static feed hub 82 includes five ports or openings 170a-170e formed in a top 172 of the head portion 150, with each port 170a-170e being fluidly connected to a respective fluid passageway 174a-174e through the static feed hub 82 for directing liquid medium and/or other fluids between the static feed hub 82 and the rotary module 84, as will be described in further detail below. Each opening 170a-170e may include a barbed fitting 176 configured to receive a process fluid line. The fittings 176 may be press-fit or threaded into each opening 170a-170e, for example.

As best shown in FIG. 4B, the static feed hub 82 includes a first passageway 174a that extends through the static feed hub 82 and between a first port 170a and a first opening 178a formed in the hub body 152. In particular, the first opening 178a is formed in the seal surface 160 of the hub body 152. To this end, a liquid suspension feed line (not shown) may be connected to the barbed fitting 176 of the first opening 170a to supply the first liquid medium to the static feed hub 82 and through the rotating seal 10 to each vessel 36, as indicated by directional arrows A3.

With continued reference to FIG. 4B, the static feed hub 82 includes a second passageway 174b that extends through the static feed hub 82 and between a second port 17ba and a second opening 178b formed in the hub body 152. In particular, the second opening 178b is formed in the base 154 of the hub body 152. To this end, a fluid line, such as a supernatant removal line (not shown), may be connected to the barbed fitting 176 of the second opening 170b to remove the second liquid medium (i.e., supernatant) from each vessel 36 and through the rotating seal 10, as indicated by directional arrows A4.

With continued reference to FIG. 4B, the static feed hub 82 includes a third and a fourth passageway 174c, 174d that extend through the static feed hub 82 and between a third port 170c and a fourth port 170d, respectively, and the internal coolant chamber 166. In that regard, the static feed hub 82 may be connected to a recirculating chiller system (not shown) configured to circulate a continuous flow of fluid coolant through the static hub 82, as indicated by directional arrows A5 in all figures. For example, a fluid coolant supply line of the chiller system may be connected to the third opening 170c to flow fluid coolant through the third passageway 174c and into the internal coolant chamber 166 and a fluid coolant return line may be connected to the fourth opening 170d to return fluid coolant from the internal coolant chamber 166 to the chiller system for recirculation.

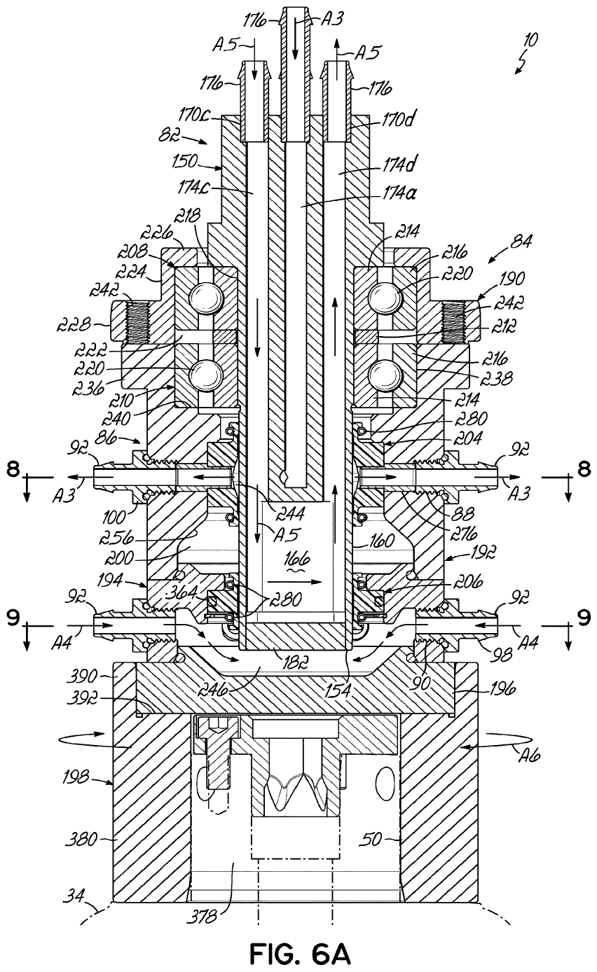

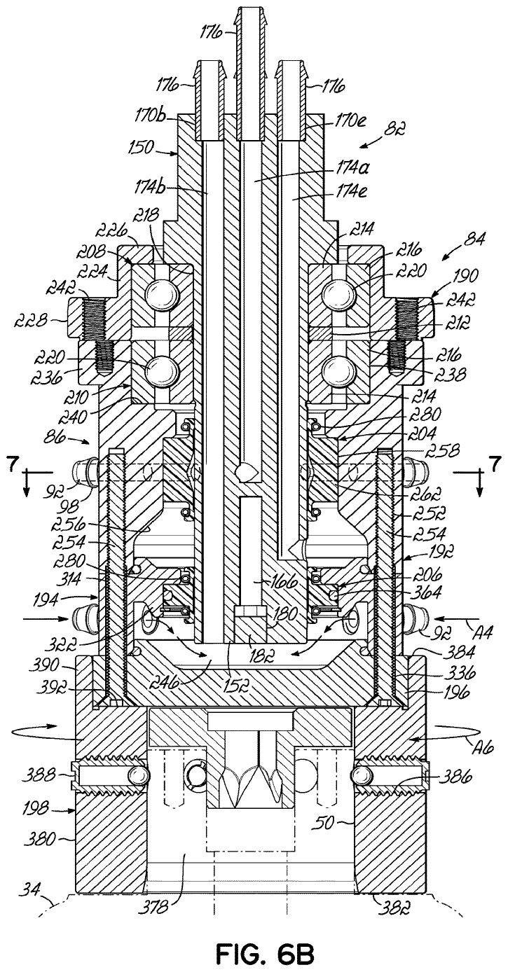

As shown in FIGS. 6A-6B, the internal coolant chamber 166 is located near the base 154 of the static feed hub 82 and is generally rectangular, or rectangular cuboid in shape. In particular, the internal coolant chamber 166 is located within the static feed hub body 152 so as to be adjacent to the seal surface 160 to best remove heat from the rotating seal 10. However, other locations and shapes of the internal coolant chamber 166 are possible and within the scope of the present invention. As shown in FIG. 6B, the internal coolant chamber 166 is accessible via an opening 180 formed in the base 154 of the static feed hub 82. However, a permanent plug seal 182 is installed in the opening 180 while the rotating seal 10 is in use.

With reference to FIG. 4B, the static feed hub 82 may include a fifth passageway 174e that extends through the static feed hub 82 and between a fifth port 170e and a third opening 178c formed in the hub body 152. In particular, the third opening 178c is formed in the seal surface 160 of the hub body 152 at a location therealong that is located axially between the first opening 178a and the base 154 of the hub body 152. While the fifth passageway 174e is not needed in the present embodiment, the design of the static feed hub 82 is intended to be modular to meet foreseeable industry needs. As such, the fifth passageway 174e may be used to remove another liquid medium from the vessels 36, such as a heavy fluid, or supply another liquid medium to the vessels 36, such as a buffer fluid, as will be described in an alternative embodiment of the rotating seal 10 below. To this end, it is possible that the static feed hub 82 only have the four openings 170a-170d and corresponding passageways 174a-174d described above.

With reference to FIGS. 4-6B, the rotary module 84 is configured to be modular to accommodate the flow of several different liquid mediums or process fluids through the rotating seal 10 and between each rotor vessel 36 and a respective external storage location, for example. In that regard, the rotary module 84 includes the body 86 which includes a bearing cap 190, a first body segment 192, a second body segment 194, a base segment 196, and a base insert 198 coupled together in a coaxial arrangement, or stack-up, to define a cavity 200 configured to operatively receive the feed hub 82 therein. The bearing cap 190, first body segment 192, and second body segment 194 are generally tubular in shape to define a generally annular sidewall of the rotary module 84. The static feed hub 82 is configured to be received within the cavity 200 of the rotary module 84 such that the bearing surface 158 of the hub body 152 is placed into engagement with a bearing assembly 202 and the seal surface 160 is placed into engagement with a first lip seal 204 and a second lip seal 206.

The bearing assembly 202 is configured to facilitate rotation of the rotary module 84 around the static feed hub 82 during rotation of the rotor assembly 12. The bearing assembly 202 may include an upper bearing 208 and a lower bearing 210 separated by a spacer ring 212. Each bearing 208, 210 may include an inner ring 214 and an outer bearing ring 216, the inner bearing ring 214 providing a bore 218 through which the bearing surface 160 of the static feed hub 82 is received. The outer ring 216 is configured to engage the bearing cap 190 or first body segment 192. The inner and outer bearing rings 214, 216 of each bearing 208, 210 cooperate to contain respective bearing members (e.g., balls, rollers, etc.) 220.

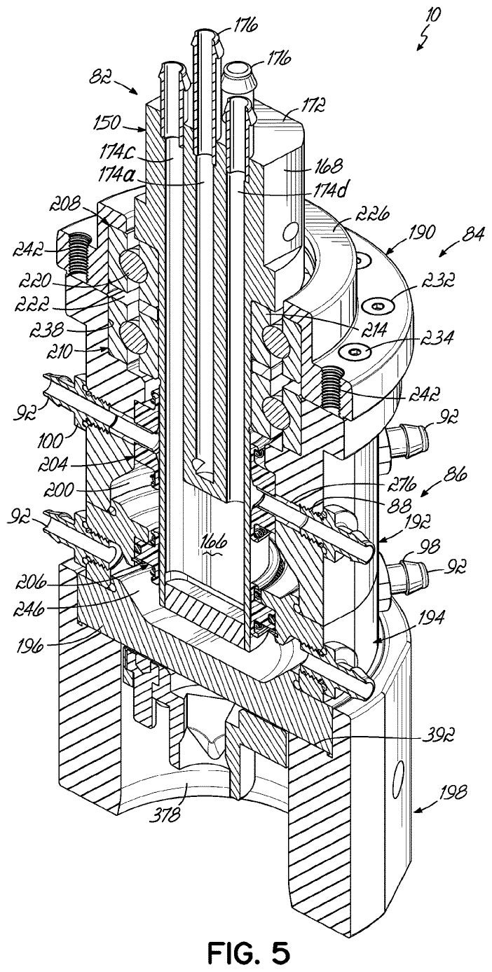

As shown in FIGS. 5-6B, the bearing assembly 202 is contained within a bearing chamber 222 formed between the bearing cap 190 and the first body segment 192 and the bearing surface 160 of the static feed hub 82. In that regard, the bearing cap 190 includes a tubular sidewall 224 that extends between an annular shoulder 226 and a flange 228. The annular shoulder 226 defines an opening 230 through which the head portion 150 of the static feed hub 82 is configured to extend, as shown. The flange 228 includes a first plurality of threaded bores 232 distributed circumferentially thereabout for receiving fasteners 234 therethrough for securing the bearing cap 190 to a top flange 236 of the first body segment 192. The top flange 236 of the first body segment 192 defines an upper inner sidewall portion 238 that extends between the top flange 236 and an annular ledge 240. As best shown in FIG. 6A, the bearing assembly 202 is located in the bearing chamber 222 and held in place axially between the annular ledge 240 of the first body segment 192, the annular shoulder 226 of the bearing cap 190, and the shoulder 156 of the static feed hub 82.

As best shown in FIG. 4A, the bearing cap 190 includes a second plurality of threaded bores 242 distributed circumferentially about the flange 228. The second plurality of threaded bores 242 are configured to receive the fasteners 76 for securing the crown 60 to the rotary module 84, as described above with respect to FIG. 2.

The first body segment 192 includes the first plurality of openings 88 distributed circumferentially thereabout and the second body segment 194 includes the second plurality of openings 90 distributed circumferentially thereabout. As will be described in further detail below, at least a first fluid transferring chamber 244 and a second fluid transferring chamber 246 are formed between the static feed hub 82 and components of the rotary module 84. In particular, the first chamber 244 is arranged to pass the first liquid medium (i.e., suspension) between the first opening 178a to the first passageway 174a in the static feed hub 82 and each of the first plurality of openings 88 formed in the first body segment 192 of the rotary module 84. The second chamber 246 is arranged to pass the second liquid medium (i.e., supernatant) between the second plurality of openings 90 formed in the second body segment 194 of the rotary module 84 and the opening 178b to the second passageway 174b in the static feed hub 82.

With reference to FIGS. 6A-7, the first body segment 192 includes a tubular body 248 that extends between the top flange 236 and a base 250. The base 250 of the first body segment 192 is configured to be secured to the second body segment 194. In that regard, the base 250 of the tubular body 248 includes a plurality of threaded blind bores 252 configured to receive fasteners 254 for securing the first body segment 192, second body segment 194, and base segment 196 together, as shown in FIG. 6B. The first body segment 192 further includes an inner sidewall 256 that extends between the base 250 and the top flange 236, and which includes the upper inner sidewall portion 238 described above. The inner sidewall 256 further defines a lip seal engagement portion 258 configured to contact the first lip seal 204, as described in further detail below. To this end, the lip seal engagement portion 258 is arranged to oppose or face the seal surface 160 of the static feed hub 82 at a location where the first opening 178a to the first passageway 174a is formed. The first body segment 192 further includes a circumferential chamfered surface 260 that extends between the base 250 and the inner sidewall 256.

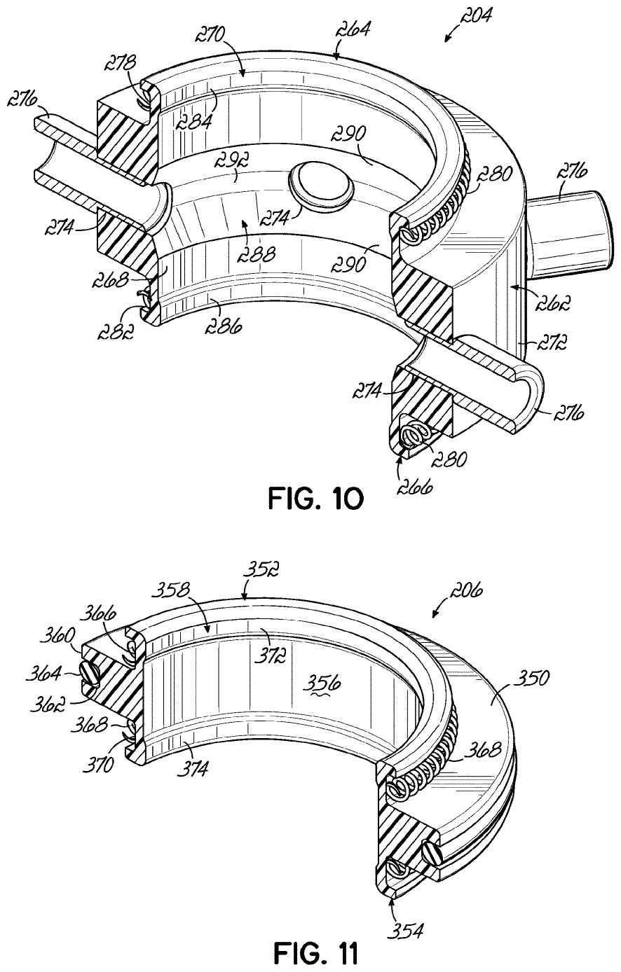

With reference to FIGS. 7 and 10, details of the first lip seal 204 will now be described. The first lip seal 204, which may otherwise be referred to as a fluid transferring lip seal, defines the first chamber 244 configured to flow the first liquid medium (i.e., suspension) between the first opening 178a in the static feed hub 82 and each of the first plurality of openings 88 formed in the first body segment 192 of the rotary module 84. In that regard, the first lip seal 204 includes a tubular body 262 having an upper sealing lip 264 and an opposite lower sealing lip 266. The tubular body 264 includes an inner sidewall or sealing face 268 that extends between the upper sealing lip 264 and the lower sealing lip 266 to define a bore 270 through the lip seal 204. To this end, the static feed hub 82 is received through the bore 270, as shown in FIGS. 6A-6B, for example. The body 262 of the lip seal 204 has a thickness, measured in a radial direction, between the inner sidewall 268 and an outer sidewall 272 of the body 262. Distributed circumferentially about the body 262 of the lip seal 204 are a plurality of radially extending bores 274. Each bore 274 extends between the inner sidewall 268 and the outer sidewall 272 of the lip seal 204 and is configured to receive a fluid guide insert 276. As described in further detail below, the plurality of bores 274 correspond to the first plurality of openings 88 distributed circumferentially about the first body segment 192. To this end, the first lip seal 204 may include six bores 274.

With continued reference to FIGS. 7 and 10, the upper sealing lip 264 defines an upper circumferential rabbet 278 configured to receive a garter spring 280 for biasing the upper sealing lip 264 against the seal surface 160 of the static feed hub 82. Similarly, the lower sealing lip 266 defines a lower circumferential rabbet 282 configured to receive a garter spring 280 for biasing the lower sealing lip 266 against the seal surface 160 of the static feed hub 82. In that regard, the upper sealing lip 264 defines an upper annular lip 284 formed on the inner sidewall 268 of the lip seal 204 that is configured to engage the seal surface 160 of the static feed hub 82 to form a first annular seal between the lip seal 204 and the static hub 82. Similarly, the lower sealing lip 266 defines a lower annular lip 286 formed on the inner sidewall 268 of the lip seal 204 that is configured to engage the seal surface 160 of the static feed hub 82 to form a second annular seal between the lip seal 204 and the static hub 82.

With continued reference to FIGS. 7 and 10, the inner sidewall 268 of the first lip seal 204 further includes a centrally located conical-shaped annular grove 288. As shown, the annular groove 288 is defined by a pair of opposed tapered surfaces 290 that extend between the inner sidewall 268 and a base 292 of the conical groove 288. Each of the plurality of bores 274 are formed through the body 262 of the first lip seal 204 so as to extend from the outer sidewall 272 of the body 262 and through conical groove 288 formed in the inner sidewall 268. To this end, the plurality of bores 274 may each be centered along the base 292 of the conical groove 288. As will be described in further detail below, the conical groove 288 and the inner sidewall 268 form the first chamber 244 configured to flow the first liquid medium (i.e., suspension) between the first opening 178a in the static feed hub 82 and each of the first plurality of openings 88 formed in the first body segment 192 of the rotary module 84.

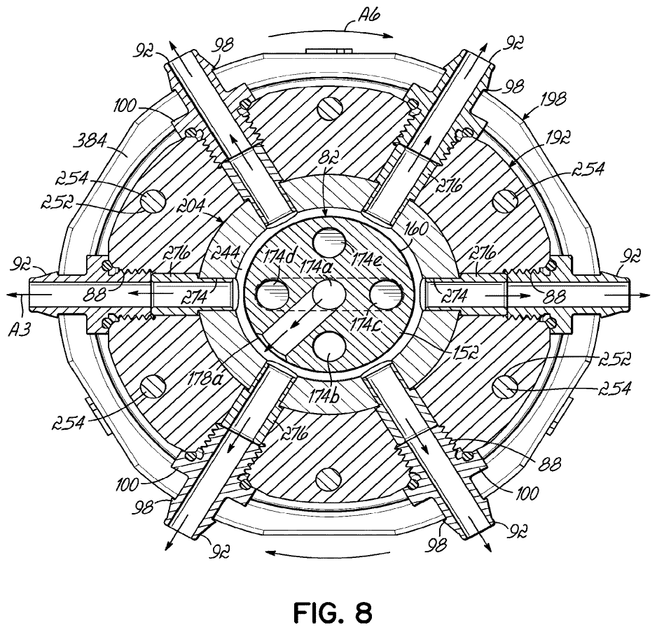

As shown in FIGS. 7 and 8, the first lip seal 204 is positioned between the seal surface 160 of the static hub 82 and the lip seal engagement portion 258 of the first body segment 192 such that each of the plurality of bores 274 formed in the first lip seal 204 are aligned with a corresponding one of the first plurality of openings 88 formed in the first body segment 192. A fluid guide insert 276 is installed within each aligned bore 274 and first opening 88 so as to extend between the lip seal 204 and the first body segment 192. As such, the fluid guides 276 fluidly couple the first lip seal 204 to the first body segment 192.

The first lip seal 204 is positioned such that the upper annular lip 284 of the lip seal 204 that engages the seal surface 160 of the static feed hub 82 axially above the first opening 178a to the first fluid passageway 174a and the lower annular lip 266 of the lip seal 204 engages the seal surface 160 axially below the first opening 178a. As a result, the conical groove 288 and inner sidewall 286 of the lip seal 204 form an annular chamber 244 about the hub body 152 that places the first opening 178a in fluid communication with each of the plurality of openings 88 formed in the first body segment 192. In that regard, the first liquid medium flows through the first passageway 174a of the static feed hub 82 and into the first chamber 244. From the first chamber 244, the first liquid medium flows through the fluid guide insert 276 positioned in each pair of aligned bores 274 and openings 88 and through each first fluid line 96a to a respective flexible bag 38 and vessel 36, as indicated by directional arrows A3. Flow of the first liquid medium as described above may be continuous while the rotary module 84 is being rotated about the static feed hub 82. Rotation of the rotary module 84 about the static feed hub 82 is indicated by directional arrows A6 in FIGS. 1-11.

With reference to FIGS. 6A-7, the second body segment 194 includes a tubular body 300 that extends between a top 302 and a base 304. The top 302 of the second body segment 194 includes an upstanding annular lip 306 and is configured to receive the base 250 of the first body segment 190. In that regard, the upstanding annular lip 306 includes a circumferential groove 308 configured to receive a gasket 310, such as an O-ring, to form a seal between the first body segment 192 and the second body segment 194. As shown, the gasket 310 is sandwiched between the chamfered surface 260 of the first body segment 192 and the annular groove 308. The base 304 of the second body segment 194 includes a chamfered surface 312 and is configured to be secured to the base segment 196. In that regard, the tubular body 300 includes a plurality of threaded bores 314 that extend between the base 304 and the top 302 that are configured to receive fasteners 254 for securing the first body segment 192, the second body segment 194, and the base segment together 196, as shown in FIG. 6B.

The second body segment 194 further includes a cupped surface 316 that extends radially inwardly from the upstanding annular lip 306 to an orifice portion 318 that defines an opening 320 through which the static feed hub 82 is configured to extend. The second body segment 194 further includes an internal annular lip 322 that extends in an axially downward direction from the orifice portion 318 to define a lip seal engagement surface 324 configured to contact the second lip seal 206, as described in further detail below. The lip seal engagement surface 324 may further include a circumferential notch 326 configured to receive a locking ring 328 configured to maintain an axial position of the second lip seal 206, if needed.

With reference to FIGS. 6A-7, the base segment 196 includes a generally disc-shaped body having a top surface 332 and a base 334. The top surface 332 is configured to receive the base 304 of the second body segment 194, as shown. In that regard, the body 330 includes a plurality of threaded bores 336, distributed circumferentially thereabout, and which extend between the base 334 and the top surface 332. To this end, the bores 336 are configured to receive a respective fastener 254 for securing the first body segment 192, the second body segment 194, and the base segment 196 together, as shown in FIG. 6B. To facilitate a sealing engagement between the second body segment 194 and the base segment 196, the body 330 of the base segment 196 further includes an upstanding annular lip 338 that extends from the top surface 332 and which includes a circumferential groove 340 configured to receive a gasket 342, such as an O-ring therein. The gasket 342 provides a seal between the second body segment 194 and the base segment 196. In particular, the gasket 242 is sandwiched between the chamfered surface 312 of the second body segment 194 and the circumferential groove 340.

The upstanding annular lip 338 defines part of a central recess 344 formed in the body 330 of the base segment 196. In that regard, the central recess 344 includes a tapered sidewall 346 that extends between the upstanding annular lip 338 and a generally flat base 348 of the recess 344. To this end, the recess 344 may be bowl or cup-shaped. As will be described in further detail below, the second lip seal 206 is positioned between the static feed hub 82 and the second body segment 194 such that the second chamber 246 is formed between the second lip seal 206, the second body segment 194, the base segment 196, and the static hub 82. In that regard, the second chamber 246 is fluidly isolated from the first chamber 244 to thereby pass the second liquid medium (i.e., supernatant) between the second plurality of openings 90 formed in the second body segment 194 of the rotary module 84 and the opening 178b to the second passageway 174b in the static feed hub 82.

The second lip seal 206 is similar in some respects to the first lip seal 204 described above. As shown in FIG. 11, the second lip seal 206 includes a tubular body 350 having an upper sealing lip 352 and an opposite lower sealing lip 354. The tubular body 350 includes an inner sidewall or sealing face 356 that extends between the upper sealing lip 352 and the lower sealing lip 354 to define a bore 358 through the lip seal 206. To this end, the static feed hub 82 is received through the bore 358, as shown in FIGS. 4A and 6A-7, for example. The body 350 of the lip seal 206 extends between the inner sidewall 356 and an outer sidewall 360 of the body 350. The outer sidewall 360 of the body 350 includes a circumferential groove 362 configured to receive a gasket 364, such as an O-ring, configured to form a seal between the outer sidewall 360 of the seal 206 and the lip seal engagement surface 324 of the second body segment 194, as shown.

With reference to FIGS. 6A-7 and 11, the upper sealing lip 352 defines an upper circumferential rabbet 366 configured to receive a garter spring 368 for biasing the upper sealing lip 352 against the seal surface 160 of the static feed hub 82. Similarly, the lower sealing lip 354 defines a lower circumferential rabbet 370 configured to receive a garter spring 368 for biasing the lower sealing lip 354 against the seal surface 160 of the static feed hub 82. In that regard, the upper sealing lip 352 defines an upper annular lip 372 formed on the inner sidewall 356 of the lip seal 206 that is configured to engage the seal surface 160 of the static feed hub 82 to form a first annular seal between the lip seal 206 and the static hub 82. Similarly, the lower sealing lip 354 defines a lower annular lip 374 formed on the inner sidewall 356 of the lip seal 206 that is configured to engage the seal surface 160 of the static feed hub 82 to form a second annular seal between the lip seal 206 and the static hub 82.

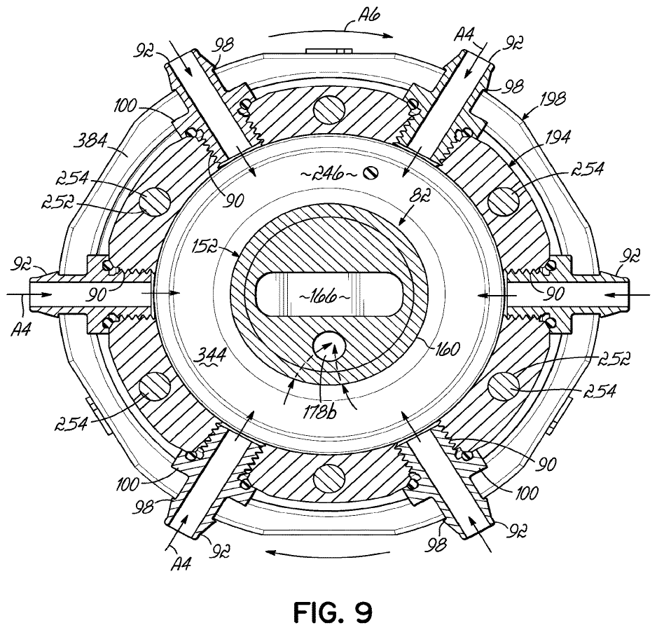

As shown in FIG. 7, the second lip seal 206 is positioned between the seal surface 160 of the static hub 82 and the lip seal engagement portion 324 of the second body segment 194. In that regard, the second lip seal 206 fluidly isolates the second chamber 246 which is formed between the second lip seal 206, the second body segment 194, the base segment 196, and the static hub 82 as shown. As a result, the second opening 178b is placed in fluid communication with each of the plurality of openings 90 formed in the second body segment 192, as shown in FIG. 9. In that regard, the second liquid medium flows from the flexible bags 38 and vessels 36 via each second fluid line 96b, through each opening 90 formed in the second body segment 192, and into the second chamber 246. From the second chamber 246, the second liquid medium flows into the second opening 178b formed in the base 154 of the static hub 82, through the second passageway 174b, and out of the static hub 82 via the second port 170b, as indicated by directional arrows A4.

The base insert 198 of the rotary module 84 is configured to receive the boss 50 of the central core 42 of the rotor 14 within a pocket 378 to thereby couple the rotary module 84 to the rotor 14, as shown in FIG. 2, for example. As shown, the pocket 378 is in part defined by the base segment 196. In any event, as best shown in FIGS. 4A and 6A-6B, the base insert 198 includes a generally tubular body 380 that extends between a base 382 and a top 384 and which includes plurality of threaded bores 386 formed therethrough. The bores 386 are distributed circumferentially about the base insert 198 and are each configured to receive a respective set screw 388 therethrough. As shown in FIG. 6B, each set screw 388 may be a ball point set screws configured to be threaded into a corresponding bore 386. To that end, each set screw 388 is threaded into a corresponding bore 386 and into engagement with surfaces of the boss 50 of the central core 42 of the rotor 14 to lock the rotary module 84 in place relative to the rotor 14.

The base insert 198 further includes an upstanding annular wall 390 that extends between an annular ledge 392 and the top 384 of the base insert 198 to define a recess 394 configured to receive the base segment 196. As shown in FIG. 4A, the base insert 198 includes a plurality bores 396 that extend between the base 382 of the base insert 198 and the annular ledge 392, with each bore 396 being configured to receive a threaded fastener 398 therethrough. The threaded fasters are then configured to be threaded into respective bores 336 formed in the body 330 of the base segment 196 to secure the base insert 198 to the base segment 196.

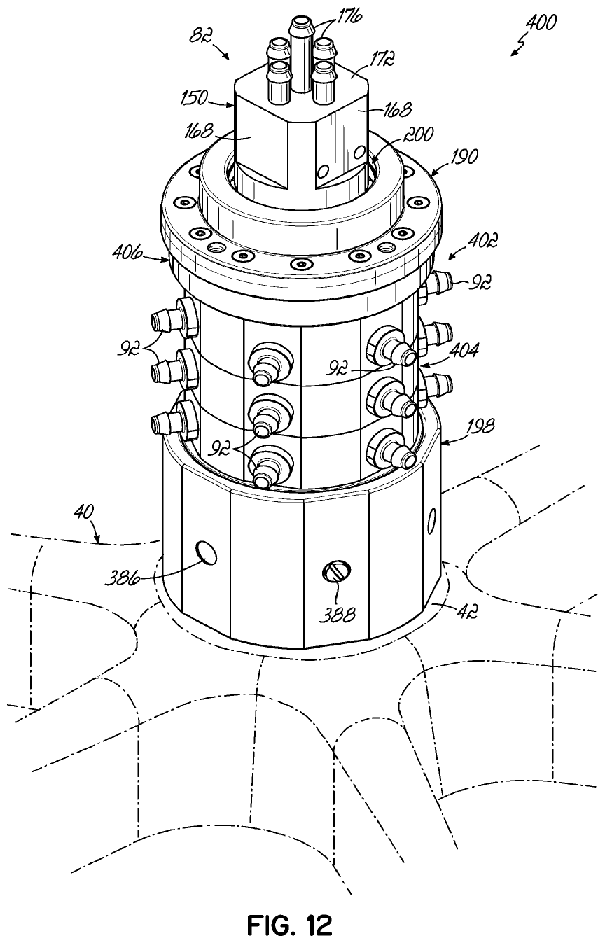

Referring now to FIGS. 12-14C, wherein like numerals represent like features, a rotating seal 400 is shown in accordance with a second embodiment of the of the present invention. Like the embodiment described above with respect to FIGS. 1-11, the rotating seal 400 is configured to be installed to a rotor (e.g., 14) to convert the rotor, which may be a batch-type centrifuge rotor, to operate as a continuous flow centrifuge rotor to increase suspension throughput through the rotor. The primary differences between the rotating seal 400 of this embodiment and the rotating seal 10 of the previously described embodiment is that the rotary module 402 includes a body 404 having three body segments. In particular, the rotary module 402 includes a first body segment 406 and two second body segments 194a, 194b. The second body segment 194a may be referred to as the upper second body segment 194a and the second body segment 194b may be referred to as the lower second body segment 194b. As a result of the three body segment 406, 194a, 194b configuration of the rotary module 402, the rotating seal 400 may flow up to three different liquid mediums or process fluids through the rotating seal 400 and between each rotor vessel and a respective external storage location while the rotor is being rotated. With respect to FIGS. 12-14C, it is noted that the suffix (i.e., “a”, “b”, etc.) behind each base reference numeral is used to denote a first and a second component. As such, the descriptions set forth above with respect to FIGS. 1-11 apply equally to reference numerals that share the same base numeral but have the addition of a suffix (i.e., “a”, “b”, etc.).

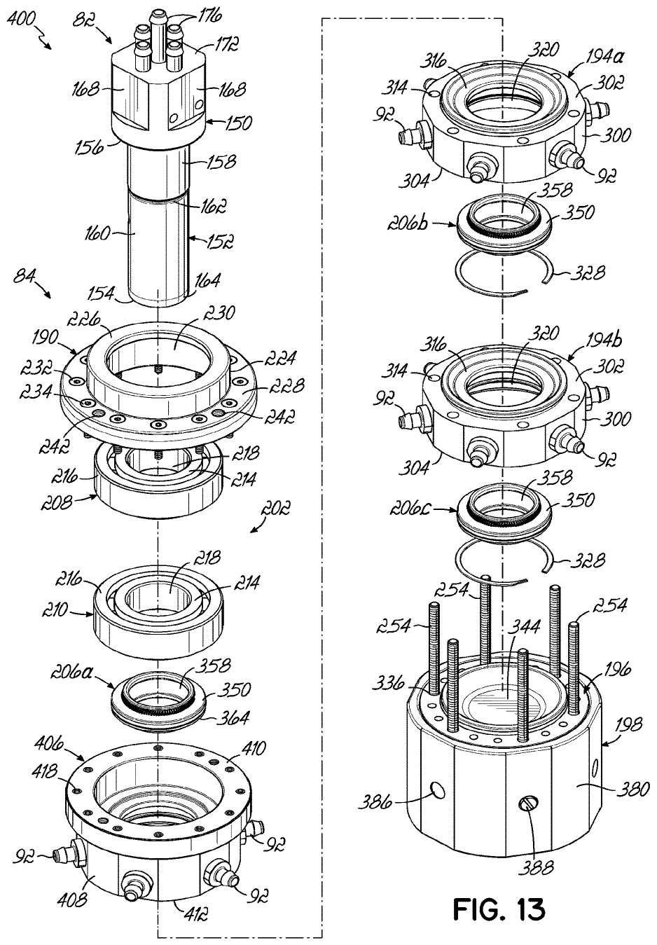

Referring now to FIGS. 12-13, the rotating seal 400 includes the static feed hub 82 which is configured to be stationary relative to the rotary module 402 which is configured to rotate about the static feed hub 82 during rotation of the rotor assembly 12 by the centrifuge drive 28. In that regard, the rotary module 402 is configured to be attached to the central core 42 of the rotor 14 to thereby couple the rotating seal 400 to the rotor 14, as shown in FIG. 12, for example.

With continued reference to FIGS. 12-13, the body 404 of the rotary module 402 includes the bearing cap 190, the first body segment 406, the upper and lower second body segments 194a, 194b, the base segment 196, and the base insert 198 coupled together in a coaxial arrangement, or stack-up, with fasteners 254 to define the cavity 200 configured to operatively receive the static feed hub 82 therein. In that regard, the static feed hub 82 is configured to be received within the cavity 200 of the rotary module 400 such that the bearing surface 158 of the hub body 152 is placed into engagement with the bearing assembly 202 and the seal surface 160 is placed into engagement with three lip seals 206a, 206b, 206c, as described in further detail below.

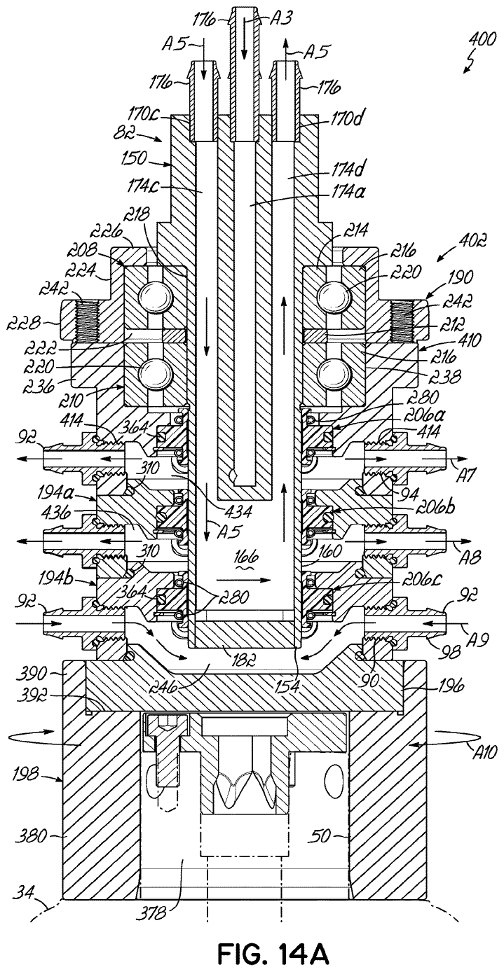

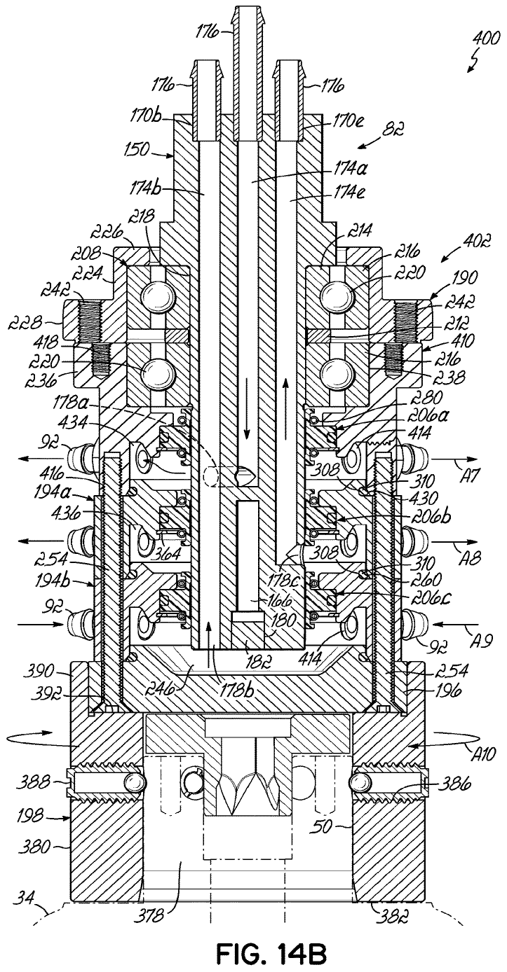

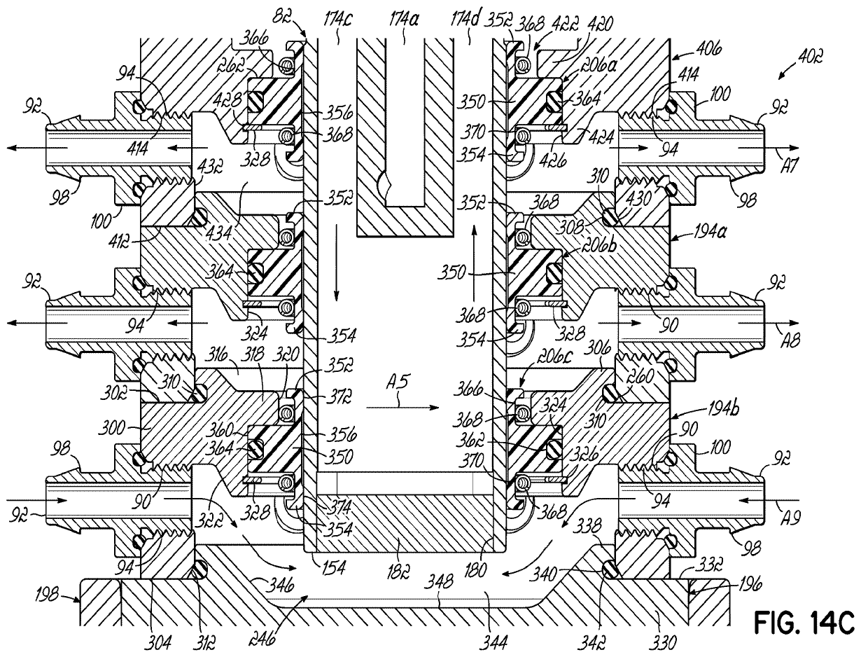

Referring now to FIGS. 13-14C, the first body segment 406 includes a tubular body 408 that extends between the top flange 410 and a base 412. The tubular body 408 includes a plurality of openings 414 distributed circumferentially thereabout. In the embodiment shown, the first body segment 406 includes six openings 414. Each of the plurality of openings 414 includes a fitting 92 and is for directing a first process fluid or liquid medium between the rotating seal 400 and a vessel of the rotor. Each opening 414 may be partially threaded to threadably receive a threaded end 94 of a respective fitting 92 (e.g., FIG. 14A). The base 412 of the first body segment 406 is configured to abut the upper second body segment 194a, as shown in FIGS. 14A-14B, for example. In that regard, the base 412 of the tubular body 408 includes a plurality of threaded blind bores 416 configured to receive a respective fastener 254 for securing the first body segment 406, the second body segments 194a, 194b, and the base segment 196 together. To this end, the flange 410 includes a plurality of threaded bores 418 distributed circumferentially thereabout for receiving fasteners 234 therethrough for securing the bearing cap 190 to the first body segment 406.

With reference to FIGS. 14A-14C, the first body segment 406 further includes an orifice portion 420 that defines an opening 422 through which the static feed hub 82 is configured to extend. The first body segment 406 further includes an internal annular lip 424 that extends in an axially downward direction from the orifice portion 420 to define a lip seal engagement surface 426 configured to contact a first lip seal 206a, as described in further detail below. The lip seal engagement surface 426 may further include a circumferential notch 428 configured to receive a locking ring 328. The locking ring 328 is configured to maintain an axial position of the first lip seal 206a, if needed. The first body segment 406 further includes a circumferential chamfered surface 430 that extends between the base 412 and an inner sidewall portion 432 of the first body segment 406. To this end, the first body segment 406 is configured to be coupled to the upper second body segment 194a such that a gasket 310 is sandwiched between the chamfered surface 430 of the first body segment 406 and the annular groove 308 of the upper second body segment 194a to form a seal therebetween, as shown.

With continued reference to FIGS. 14A-14C, a first fluid transferring chamber 434, a second fluid transferring chamber 436, and a third fluid transferring chamber 246 are formed between the static feed hub 82 and components of the rotary module 402. In particular, the first chamber 434 is arranged to pass a first liquid medium (i.e., process fluid suspension) between the opening 178a to the first passageway 174a in the static feed hub 82 and each of the plurality of openings 414 formed in the first body segment 406 of the rotary module 402, as indicated by directional arrows A7 in FIGS. 14A-14C. The second chamber 436 is arranged to pass a second liquid medium (i.e., a buffer fluid) between the plurality of openings 90 formed in the upper second body segment 194 of the rotary module 84 and the opening 178c to the fifth passageway 174e in the static feed hub 82, as indicated by directional arrows A8 in FIGS. 14A-14C. The third chamber 246 is arranged to pass a third liquid medium (i.e., supernatant, heavy material, or pellet) between the plurality of openings 90 formed in the lower second body segment 194b of the rotary module 402 and the opening 178b to the second passageway 174b in the static feed hub 82, as indicated by directional arrows A9 in FIGS. 14A-14C. To this end, flow of each liquid medium as described above may be continuous while the rotary module 402 is being rotated about the static feed hub 82, as indicated by directional arrows A10 in FIGS. 14A-14C. It will be understood that the inventive aspects of the rotating seal 400 are not limited to the flow directions described and shown in the figures, and that flow directions through the rotating seal 400 may be changed as required by the application.

With continued reference to FIGS. 14A-14C, the first body segment 406, the second body segments 194a, 194b, and the base segment 196 are coupled together in a coaxial arrangement that is configured to receive the static hub 82 to form each fluid transferring chamber 434, 436, 246. In that regard, the lower second body segment 194b is installed to the base segment 196 with lip seal 206c being positioned between the seal surface 160 of the static hub 82 and the lip seal engagement portion 324 of the lower second body segment 194b. In that regard, the third chamber 246 is formed between the lip seal 206c, the lower second body segment 194b, the base segment 196, and the static hub 82, as shown. As a result, the second opening 178b of the feed hub 82 is placed in fluid communication with each of the plurality of openings 90 formed in the second body segment 192b, as shown in FIG. 14C, for example. In that regard, the third liquid medium flows from each rotor vessel via a respective fluid line, through each opening 90 formed in the second body segment 192b, and into the third chamber 246. From the third chamber 246, the third liquid medium flows into the second opening 178b formed in the base 154 of the static hub 82, through the second passageway 174b, and out of the static hub 82 via the second port 170b, as indicated by directional arrows A9.

The upper second body segment 194a is installed to the lower second body segment 194b such that a gasket 310 is sandwiched between the chamfered surface 260 of the upper body segment 194a and the annular groove 308 of the lower second body segment 194b to form a seal therebetween. A lip seal 206b is positioned between the seal surface 160 of the static hub 82 and the lip seal engagement portion 324 of the upper second body segment 194a. In that regard, the second chamber 436 is formed between the lip seal 206b, the upper second body segment 194a, the lower second body segment 194b, the lip seal 206c, and the seal surface 160 of the static hub 82, as shown. As a result, the third opening 178c of the feed hub 82 is placed in fluid communication with each of the plurality of openings 90 formed in the upper second body segment 194a, as shown in FIG. 14C, for example. In that regard, the second liquid medium flows from each rotor vessel via a respective fluid line, through each opening 90 formed in the upper second body segment 192a, and into the second chamber 436. From the second chamber 436, the second liquid medium flows into the third opening 178c, through the fifth passageway 174e, and out of the static hub 82 via the fifth port 170e, as indicated by directional arrows A8.

As described above, the first body segment 406 is installed to the upper second body segment 194a. A lip seal 206a is positioned between the seal surface 160 of the static hub 82 and the lip seal engagement surface 426 of the first body segment 406. In that regard, the first chamber 434 is formed between the lip seal 206a, the first body segment 406, the upper second body segment 194a, the lip seal 206b, and the seal surface 160 of the static hub 82, as shown. As a result, the first opening 178a of the feed hub 82 is placed in fluid communication with each of the plurality of openings 414 formed in the first body segment 414, as shown in FIG. 14C, for example. In that regard, the first liquid medium flows through the first passageway 174a of the static feed hub 82 and into the first chamber 434. From the first chamber 434, the first liquid medium flows through each of the plurality of openings 414 in the first body segment 406 and through a respective fluid line to a connected vessel, as indicated by directional arrows A7.

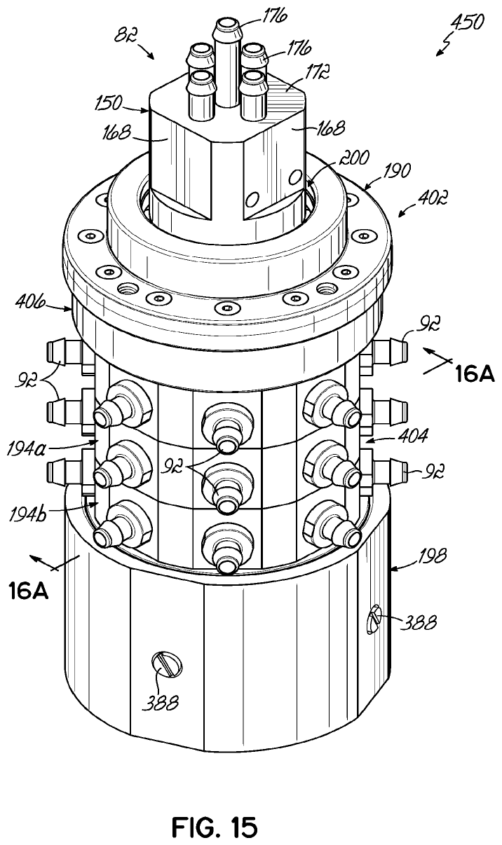

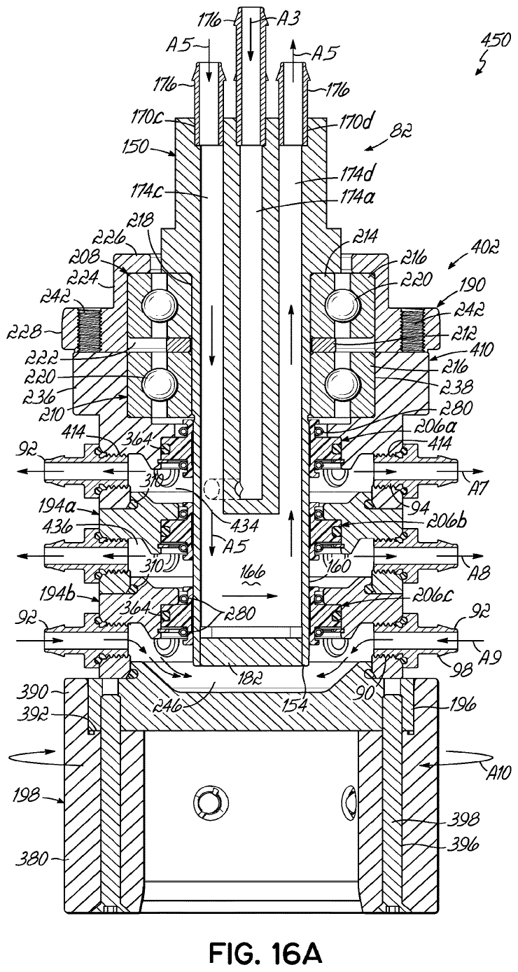

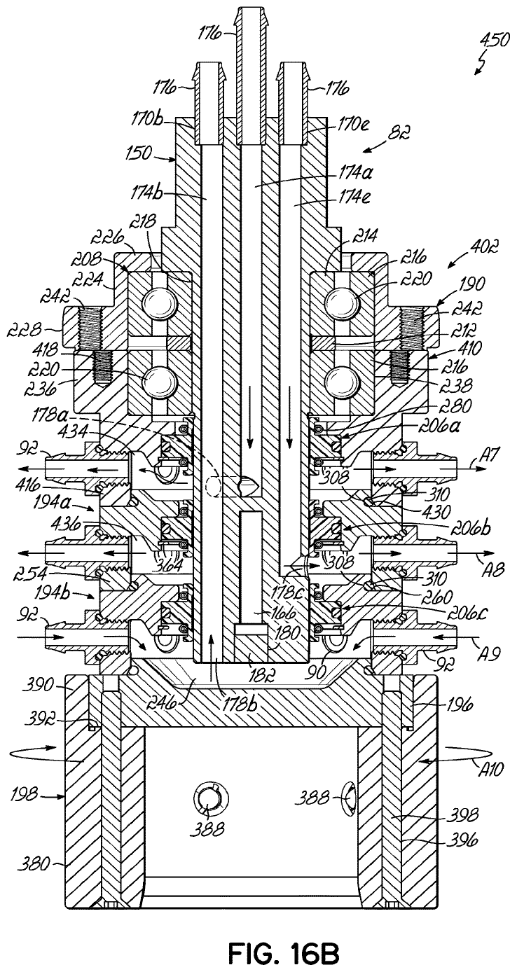

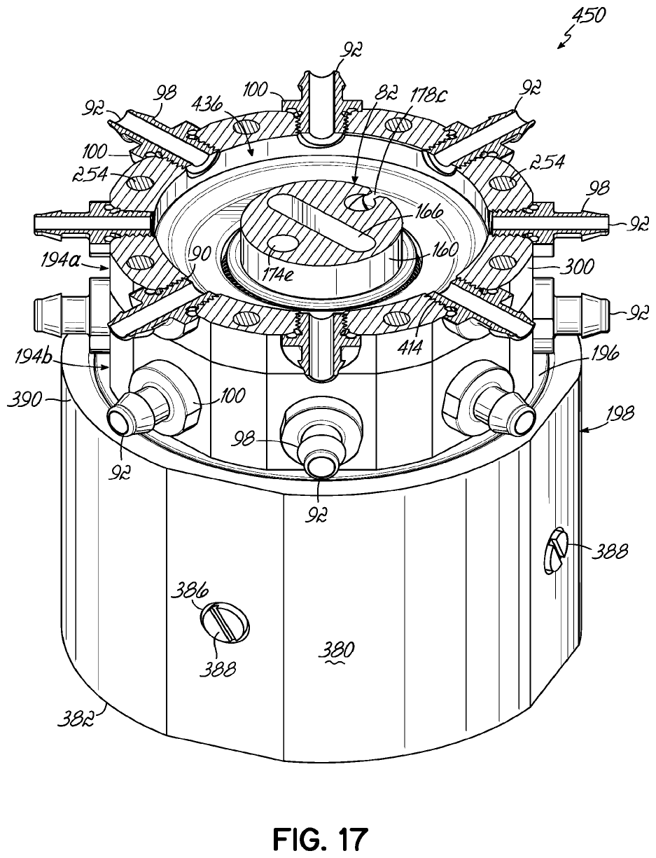

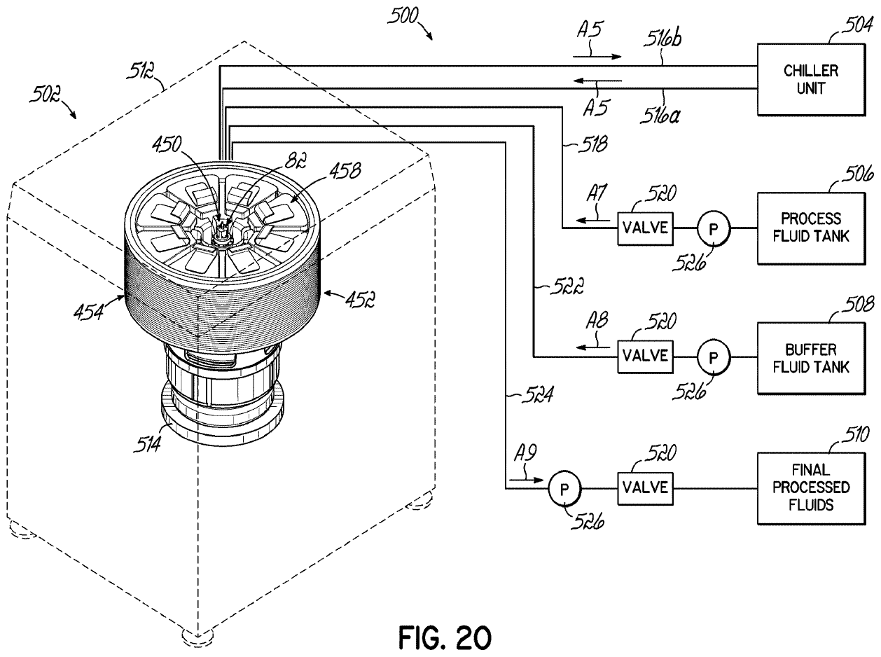

Referring now to FIGS. 15-20, wherein like numerals represent like features, a rotating seal 450 is shown in accordance with a third embodiment of the of the present invention. Like the embodiment described above with respect to FIGS. 12-14C, the rotating seal 450 is configured to be installed to a rotor (e.g., FIG. 20) to convert the rotor, which may be a batch-type centrifuge rotor, to operate as a continuous flow centrifuge rotor to increase suspension throughput through the rotor. The primary differences between the rotating seal 450 of this embodiment and the rotating seal 400 of the previously described embodiment is that the first body segment 406 includes eight openings 414 distributed circumferentially about the tubular body 408, rather than six, for example. Each of the upper and lower second body segments 194a, 194b also include eight openings 90 distributed circumferentially about their respective tubular body 300 (e.g., FIG. 17). The additional openings 414, 90 in each body segment 414, 194a, 194b, serve to accommodate a rotor having eight vessels rather than six, for example. To this end, other than the change in the quantity of openings 414, 90 in each body segment 414, 194a, 194b, the rotating seal 450 of this embodiment is functionally equivalent to the rotating seal 400 described above with respect to FIGS. 12-14C, and therefore those details will not be redescribed for purposes of brevity. With respect to FIGS. 15-20, it is noted that the suffix (i.e., “a”, “b”, etc.) behind each base reference numeral is used to denote a first and a second component. As such, the descriptions set forth above with respect to FIGS. 1-14C apply equally to reference numerals that share the same base numeral but have the addition of a suffix (i.e., “a”, “b”, etc.).

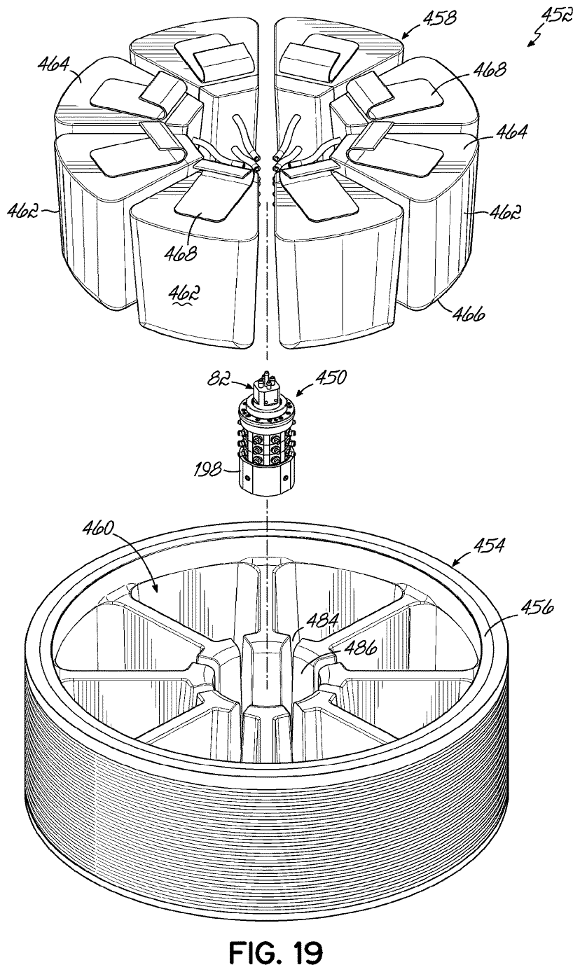

With reference to FIGS. 18-19, the rotating seal 450 is shown installed to an exemplary rotor assembly 452. The rotor assembly 452 includes a centrifuge rotor 454 and the rotating seal 450 is for converting the rotor 454, which may be a batch-type centrifuge rotor, into a continuous flow rotor, as described above. The exemplary rotor 454 is described in detail in Intl. Pub. No. WO 2021/252456, published Dec. 16, 2021, the disclosure of which is incorporated by reference herein in its entirety. However, while aspects of the rotating seal 450 are shown and described in the context of certain types of centrifuge rotors, it will be understood that the same inventive concepts related to aspects of the rotating seal 450 may be implemented with different centrifuge rotors and related systems. To this end, the drawings are not intended to be limiting.

With continued reference to FIGS. 18-19, the rotor assembly 452 includes the rotor 454 having a rotor body 456 configured to support a plurality of vessels 458 arranged for rotation about the rotational axis All of the centrifuge rotor 454. In that regard, the rotor body 456 includes a plurality of receiving chambers, or rotor wells 460, arranged symmetrically about the rotational axis A11 of the rotor 454. In the embodiment shown, the rotor 454 includes eight rotor wells 460 for supporting eight vessels 458. Each vessel 458 is configured to receive a volume of a liquid suspension for centrifugation, as will be described in further detail below. In particular, each vessel 458 includes a vessel body 462 that extends between a top 464 and a base 466 of the vessel body 462. Each vessel 458 includes a handle 468 located on the top 464 of the vessel 458 which may be used to insert/remove the vessel 458 to/from the respective rotor well 460, for example.

As shown to FIG. 18, each vessel 458 includes a first port 470, a second port 472, and a third port 474 formed in the body 462 of the vessel 458. The first port 470 is for receiving a first fluid line 476a connected to one of the plurality of openings 414 of the first body segment 406 of the rotary module 402 for flowing the first liquid medium (i.e., suspension) from the rotating seal 450 to the vessel 458. In that regard, the first port 470 is located near the top 464 of the vessel 458. The second port 472 is for receiving a second fluid line 476b connected to one of the plurality of openings 90 of the upper second body segment 194a of the rotary module 402 for flowing the second liquid medium (i.e., a buffer fluid) from the rotating seal 450 to the vessel 458. In that regard, the second port 472 is located axially below the first port 470. The third port 474 is for receiving a third fluid line 476c connected to one of the plurality of openings 90 of the lower second body segment 194b of the rotary module 402 for flowing the third liquid medium (i.e., heavy material or pellet) from the vessel 458 to the rotating seal 450. The third port 474 is located axially below the second port 472 so as to be near the base 466 of the vessel 458. To this end, the end of the third fluid line 476c positioned within the vessel 458 may include an intake 477 to facilitate collection and removal of the heavy material or pellet, for example. It will be understood that the inventive aspects of the rotating seal 450 are not limited to the flow directions described and shown in the figures, and that flow directions through the rotating seal 450 may be changed as required by the application.

With continued reference to FIG. 18, the rotor body 456 includes a central bore 478 configured to receive a hub 480 to which the rotating seal 450 may be attached. In particular, the base insert 198 of the rotary module 402 is configured to receive a boss 482 of the hub 480 within the pocket 378. The rotating seal 450 is then coupled to the hub 480 using the set screws 388. When so positioned, each grouping of three fluid lines 476a, 476b, 476c may be connected between each vessel 458 and the respective openings 414, 90 of each body segment 406, 194a, 194b, as shown. In that regard, each grouping of fluid lines 476a, 476b, 476c is routed through a channel 484 formed in an inner wall 486 of the rotor body 456. Each channel 484 is configured to secure each grouping of fluid lines 476a, 476b, 476c during centrifugal rotation of the rotor assembly 452.

FIG. 20 depicts an exemplary continuous flow centrifugation system 500 including a centrifuge 502 connected to a recirculating chiller unit 504, a process fluid tank 506, a buffer fluid tank 508, and a final processed fluids storage 510. The centrifuge 502 includes a housing 512, a drive 514, and the rotor assembly 452 coupled to the drive 514. In operation, the drive 514 imparts rotation to the rotor assembly 452 and the centrifugal force created by spinning the rotor 454 causes the solids in the process fluid stored in each rotor vessel 458 to settle out and form a generally solid pellet toward the bottom of the vessel 458.

With continued reference to FIG. 20, the rotor assembly 452 includes the rotating seal 450 which converts the rotor 454 to a continuous flow rotor, as described above. The rotating seal 450, and more particularly the static feed hub 82, is fluidly connected to the recirculating chiller unit 504, the process fluid tank 506, the buffer fluid tank 508, and the final processed fluids storage 510. In that regard, a fluid coolant supply line 516a and a fluid coolant return line 516b of the chiller unit 504 are connected to the static feed hub 82 to circulate fluid coolant through the static feed hub 82, as indicated by directional arrows A5. The fluid coolant supply line 516a may be connected to the third opening 170c of the static feed hub 82 to flow fluid coolant through the third passageway 174c and into the internal coolant chamber 166. The fluid coolant return line 516b may be connected to the fourth opening 170d of the static feed hub 82 to return fluid coolant from the internal coolant chamber 166 to the chiller unit 504 for recirculation. The process fluid tank 506 is connected to the static feed hub 82 with a process fluid line 518. The process fluid line 518 may include a pump 526 and a valve 520 configured to control flow of the process fluid to the rotating seal 450, for example. The process fluid line 518 may be connected to the first opening 170a of the static feed hub 82 to supply a continuous flow of process fluid to each vessel 458, as indicated by directional arrow A7. The buffer fluid tank 508 is connected to the static feed hub 82 with a buffer fluid line 522. The buffer fluid line 522 may include a pump 526 and a valve 520 configured to control flow of the process fluid to the rotating seal 450, for example. The buffer fluid line 518 may be connected to the fifth opening 170e of the static feed hub 82 to supply a continuous flow of buffer fluid to each vessel 458, as indicated by directional arrow A8. The final processed fluids collection 510 is connected to the static feed hub 82 with a processed fluids line 524. The processed fluids line 524 may include a pump 526 and a valve 520 configured to control flow of the processed fluids from each vessel 458 to the processed fluids collection 510, for example. To this end, the processed fluids line 524 may be connected to the second opening 170b of the static feed hub 82 to supply a continuous flow of processed fluids from each vessel 458 to the processed fluids collection 510, as indicated by directional arrow A9.

While the invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

What is claimed:

1. A rotating seal for a batch centrifuge rotor having a plurality of vessels arranged for rotation about a rotational axis of the centrifuge rotor, each vessel being configured to hold a liquid medium for centrifugation and including a liquid medium inlet port and a liquid medium outlet port, the rotating seal being configured to be received by a hub of the centrifuge rotor to convert the batch centrifuge rotor to operate as a continuous flow centrifuge rotor, the rotating seal comprising:
a static feed hub including a head portion configured to extend through a lid of the centrifuge rotor and a cylindrical hub body that extends from the head portion to a base and which includes an internal coolant chamber, the static feed hub further including a first passageway fluidly connecting a first port located on the head portion to a first opening formed in the hub body, a second passageway fluidly connecting a second port located on the head portion to a second opening formed in the hub body, and a third and a fourth passageway fluidly connecting a third and a fourth port located on the head portion to the internal coolant chamber through which fluid coolant is provided to adjust a temperature of the static feed hub;
a rotary module including a body having an annular sidewall and a base that define a cavity configured to operatively receive the feed hub therein, the base including a base insert configured to couple the rotary module to the hub of the centrifuge rotor for rotation of the rotary module about the static feed hub, the body including:
a first plurality of openings formed in the annular sidewall, each of the first plurality of openings being in fluid communication with the opening to the first passageway and configured to be fluidly connected to the liquid medium inlet port of one vessel of the centrifuge rotor with a first fluid line to pass a first liquid medium between the first fluid passageway of the static feed hub and the liquid medium inlet port of the vessel of the centrifuge rotor; and
a second plurality of openings formed in the annular sidewall, each of the second plurality of openings being in fluid communication with the opening to the second passageway and configured to be fluidly connected to the liquid medium outlet port of one vessel of the centrifuge rotor with a second fluid line to pass a second liquid medium between the liquid medium outlet port and the second fluid passageway of the static feed hub;
a bearing assembly located within the rotary cavity and between the body of the static feed hub and the body of the rotary module; and
at least one lip seal located within the rotary cavity and between the body of the static feed hub and the body of the rotary module.

2. The rotating seal of claim 1, further comprising:
a first chamber formed between the static feed hub and the rotary module configured to pass the first liquid medium between the first opening to the first passageway and each of the first plurality of openings formed in the annular sidewall of the rotary module; and
a second chamber formed between the static feed hub and the rotary module configured to pass the second liquid medium between the second opening to the second passageway and each of the second plurality of openings formed in the annular sidewall of the rotary module, the second chamber being fluidly isolated from the first chamber.

3. The rotating seal of claim 1, wherein the rotary module comprises a bearing cap coupled to a top of the body of the rotary module to form a bearing chamber configured to receive the bearing assembly.

4. The rotating seal of claim 3, wherein the bearing cap includes an opening through which the static feed hub extends.

5. The rotating seal of claim 1, wherein the body of the rotary module includes a first body segment, a second body segment, and a base segment coupled together in a coaxial arrangement to define the cavity configured to receive the static feed hub.

6. The rotating seal of claim 5, wherein the first body segment includes the first plurality of openings formed therein and the second body segment includes the second plurality of openings formed therein.

7. The rotating seal of claim 6, further comprising:
a first chamber formed between the static feed hub and the first body segment configured to pass a first liquid medium between the first opening to the first passageway and each of the first plurality of openings formed in the first body segment; and
a second chamber formed between the static feed hub and the second body segment configured to pass a second liquid medium between the second opening to the second passageway and each of the second plurality of openings formed in the second body segment, the second chamber being fluidly isolated from the first chamber.

8. The rotating seal of claim 7, wherein the at least one lip seal includes a first lip seal and a second lip seal, the first lip seal being positioned between the static feed hub body and the first plurality of openings formed in the first body segment such that the first chamber is formed between the first lip seal and the hub body.

9. The rotating seal of claim 8, wherein the first chamber is annular.

10. The rotating seal of claim 8, wherein the first lip seal includes a plurality of radially extending bores configured to pass the first liquid medium between the first chamber and the first plurality of openings formed in the annular sidewall of the rotary module.

11. The rotating seal of claim 10, wherein each of the plurality of radially extending bores includes a fluid guide that extends into a corresponding one of the first plurality of openings formed in the annular sidewall of the rotary module.

12. The rotating seal of claim 8, wherein the second lip seal is positioned between the static feed hub body and the second body segment such that the second chamber is formed between the second lip seal and the second body segment, the base segment, and the base of the static feed hub.

13. The rotating seal of claim 12, wherein the second opening to the second fluid passageway is formed in the base of the static feed hub.

14. A rotor assembly, comprising:
a housing including a cover;
a rotor configured to rotate with the housing and the cover, the rotor including a plurality of vessels arranged about a rotational axis of the rotor and being adapted to receive a volume of liquid medium for centrifugation, each of the plurality of vessels including a liquid medium inlet port and a liquid medium outlet port; and
the rotating seal of claim 1.

15. The rotor assembly of claim 14, further comprising a plurality of fluid line supports positioned between the rotating seal and the plurality of vessels of the rotor to maintain a position of each first and second fluid line during rotation of the rotor.

16. The rotor assembly of claim 15, wherein each of the plurality of fluid line supports includes a body having a first passageway configured to direct the first fluid line from one of the first plurality of openings to the liquid medium inlet port of one vessel of the rotor and a second passageway configured to direct the second fluid line from one of the second plurality of openings to the liquid medium outlet port of the same one vessel of the rotor.

17. The rotor assembly of claim 15, further comprising a crown removably attachable to the rotary module of the rotating seal to secure the plurality of fluid line supports during rotation of the rotor.

18. The rotor assembly of claim 17, wherein the crown includes an opening through which the head portion of the static feed hub is configured to extend.

19. In combination, a centrifuge and the rotor assembly of claim 14.

20. A rotating seal for a batch centrifuge rotor having a plurality of vessels arranged for rotation about a rotational axis of the centrifuge rotor, each vessel being configured to hold a liquid medium for centrifugation and including a liquid medium inlet port and a first and a second liquid medium outlet port, the rotating seal being configured to be received by a hub of the centrifuge rotor to convert the batch centrifuge rotor to operate as a continuous flow centrifuge rotor, the rotating seal comprising:
a static feed hub including a head portion and a cylindrical hub body that extends from the head portion to a base and which includes an internal coolant chamber, the static feed hub further including a first passageway fluidly connecting a first port located on the head portion to a first opening formed in the hub body, a second passageway fluidly connecting a second port located on the head portion to a second opening formed in the hub body, a third passageway fluidly connecting a third port located on the head portion to a third opening formed in the hub body, and a fourth and fifth passageway fluidly connecting a fourth and a fifth port located on the head portion to the internal coolant chamber through which fluid coolant is provided to adjust a temperature of the static feed hub;
a rotary module including a body having an annular sidewall and a base that define a cavity configured to operatively receive the feed hub therein, the base including a base insert configured to couple the rotary module to the hub of the centrifuge rotor for rotation of the rotary module about the static feed hub, the body including:
a first plurality of openings formed in the annular sidewall, each of the first plurality of openings being in fluid communication with the first opening to the first passageway and configured to be fluidly connected to the liquid medium inlet port of one vessel of the centrifuge rotor with a first fluid line to pass a first liquid medium between the first fluid passageway of the static feed hub and the liquid medium inlet port of the vessel of the centrifuge rotor;
a second plurality of openings formed in the annular sidewall, each of the second plurality of openings being in fluid communication with the second opening to the second passageway and configured to be fluidly connected to the first liquid medium outlet port of one vessel of the centrifuge rotor with a second fluid line to pass a second liquid medium between the liquid medium outlet port and the second fluid passageway of the static feed hub; and
a third plurality of openings formed in the annular sidewall, each of the third plurality of openings being in fluid communication with the third opening to the third passageway and configured to be fluidly connected to the second liquid medium outlet port of one vessel of the centrifuge rotor with a third fluid line to pass a third liquid medium between the second liquid medium outlet port and the third fluid passageway of the static feed hub;
a bearing assembly located within the rotary cavity and between the body of the static feed hub and the body of the rotary module; and
at least one lip seal located within the rotary cavity and between the body of the static feed hub and the body of the rotary module.

21. The rotating seal of claim 20, further comprising:
a first chamber formed between the static feed hub and the rotary module configured to pass the first liquid medium between the first opening to the first passageway and each of the first plurality of openings formed in the annular sidewall of the rotary module;
a second chamber formed between the static feed hub and the rotary module configured to pass the second liquid medium between the second opening to the second passageway and each of the second plurality of openings formed in the annular sidewall of the rotary module; and
a third chamber formed between the static feed hub and the rotary module configured to pass the third liquid medium between the third opening to the third passageway and each of the third plurality of openings formed in the annular sidewall of the rotary module;
wherein the first chamber, the second chamber, and the third chamber are fluidly isolated from each other.

22. The rotating seal of claim 20, wherein the rotary module comprises a bearing cap coupled to a top of the body of the rotary module to form a bearing chamber configured to receive the bearing assembly.

23. The rotating seal of claim 22, wherein the bearing cap includes an opening through which the static feed hub extends.

24. The rotating seal of claim 20, wherein the body of the rotary module includes a first body segment, a second body segment, a third body segment, and a base segment coupled together in a coaxial arrangement to define the cavity configured to receive the static feed hub.

25. The rotating seal of claim 24, wherein the first body segment includes the first plurality of openings formed therein, the second body segment includes the second plurality of openings formed therein, and the third body segment includes the third plurality of openings formed therein.

26. The rotating seal of claim 25, further comprising:
a first chamber formed between the static feed hub and the rotary module configured to pass the first liquid medium between the first opening to the first passageway and each of the first plurality of openings formed in the annular sidewall of the rotary module;
a second chamber formed between the static feed hub and the rotary module configured to pass the second liquid medium between the second opening to the second passageway and each of the second plurality of openings formed in the annular sidewall of the rotary module; and
a third chamber formed between the static feed hub and the rotary module configured to pass the third liquid medium between the third opening to the third passageway and each of the third plurality of openings formed in the annular sidewall of the rotary module;
wherein the first chamber, the second chamber, and the third chamber are fluidly isolated from each other.

27. The rotating seal of claim 26, wherein the at least one lip seal comprises:
a first lip seal positioned between the static feed hub body and the first body segment;
a second lip seal positioned between the static feed hub body and the second body segment; and
a third lip seal positioned between the static feed hub body and the third body segment.

28. The rotating seal of claim 27, wherein the first chamber and the second chamber are annular.

29. The rotating seal of claim 27, wherein the third chamber is formed between the third lip seal and the third body segment, the base segment, and the base of the static feed hub.

30. The rotating seal of claim 29, wherein the third opening to the third fluid passageway is formed in the base of the static feed hub.

31. A rotor assembly, comprising:
a rotor including a plurality of vessels arranged about a rotational axis of the rotor and being adapted to receive a volume of liquid medium for centrifugation, each of the plurality of vessels including a liquid medium inlet port, a first liquid medium outlet port, and a second liquid medium outlet port; and
the rotating seal of claim 20.

32. In combination, a centrifuge and the rotor assembly of claim 31.
